(19) United States
(12) Patent Application Publication
(10) Pub. No.: US 2024/0225010 A1
(43) Pub. Date: Jul. 11, 2024

(54) ENCAPSULATED MICROBIAL COMPOSITIONS AND METHODS OF MAKING THE SAME

(71) Applicant: Monsanto Technology LLC, St. Louis, MO (US)

(72) Inventors: Adil ANJEM, St. Louis, MO (US); Tracy BUCHOLZ, St. Louis, MO (US); Mingya HUANG, St. Louis, MO (US); Ming Woei LAU, St. Louis, MO (US)

(21) Appl. No.: 18/286,005

(22) PCT Filed: Apr. 8, 2022
(86) PCT No.: PCT/US2022/023995

§ 371 Date: Oct. 6, 2023

Related U.S. Application Data
(60) Provisional application No. 63/172,898, filed on Apr. 9, 2021.

(51) Int. Cl. A01N 63/27; A01N 25/28; A01P 21/00

(52) U.S. Cl. CPC A01N 63/27; A01N 25/28; A01P 21/00

(57) ABSTRACT

Encapsulated microbial compositions with increased stability, which, for example, can be applied to a plant seed to promote growth and/or provide pest control, and methods for preparing such encapsulated microbial compositions with increased stability are described. The method can include combining a microbe and at least one hydrogel, such as an alginate, to form a precursor mixture, solidifying the precursor mixture with a cross-linking agent including a divalent cation, a divalent cation salt, or a combination thereof to form an intermediate microbial composition, and drying the intermediate microbial composition to form the encapsulated microbial composition.

### CROSS-REFERENCE TO RELATED APPLICATION

This application claims the benefit of, and priority to, U.S. Provisional Patent Application No. 63/172,898, filed Apr. 9, 2021, the entire disclosure of which is incorporated herein by reference.

### TECHNICAL FIELD

The disclosure relates generally to encapsulated microbial compositions with increased stability for applications, such as plant seed treatments. The disclosure further relates generally to methods of preparing such encapsulated microbial compositions with increased stability and methods for applying the encapsulated microbial compositions to a plant seed.

### BACKGROUND

This section provides background information related to the present disclosure which is not necessarily prior art.

The microflora surrounding plants is very diverse, including bacteria, fungi, yeast, and algae. Microbes (also referred to as microorganisms) that make up the plant microbiome originate from various sources including seeds, plants, soil, pollinators and other animals, as well as the environment. Some of these microbes are beneficial to their plant hosts and can promote plant growth and crop productivity while others are disease causing agents, often referred to as pathogens. There is an increased interest in the use of microbial agents in agriculture, horticulture, forestry and environmental management to improve plant traits. A number of microorganisms known to be present in a zone of soil surrounding a plant root, generally known as rhizosphere and rhizoplane, have received attention for their ability to promote plant growth. In addition, it has been shown that microorganisms can be used as biological control agents to increase agricultural productivity and efficiency, for example, by opposing plant pathogens and/or improving plant growth. Some microorganisms can enhance the adaptive potential of their hosts through a number of mechanisms, such as the fixation of molecular nitrogen, the mobilization of soil nutrients (e.g., iron, phosphorous, sulfur, etc.), the synthesis of phytohormones and vitamins, and the decomposition of plant materials in soils which can increase soil organic matter. By inoculating plant seeds and/or the soil with certain beneficial microorganisms, plants can be supplied with important nutrients or beneficial factors that control pests and/or enhance their growth and development. However, microorganisms typically need to remain viable to positively affect plant health and traits and may not be stable in storage or the environment or on plants or plant seeds.

Thus, there is a need for improved methods and compositions comprising such beneficial microorganisms, which can be incorporated, for example, into seed treatment formulations, coatings and/or biofertilizers or other agricultural applications, such as for long-term storage and later use. However, the preservation of the viability, structure and function of microorganisms during their storage, shipment and application to plants or plant seeds, especially at varying temperatures and humidity, has proven challenging. Although methods and compositions have been developed for stabilizing biological materials, there remains a need for improved compositions and methods for formulating microbes, such as bacteria or fungi, for agricultural applications. Indeed, many non-spore forming bacteria and fungal strains are particularly sensitive to storage and formulation conditions and may not remain viable during storage and agricultural applications with existing formulation approaches and strategies. Therefore, a further need exists for methods for producing more stable compositions for preservation of a wide range of biological materials over extended periods of time at varying temperatures and humidity, such as those encountered during shipping and storage of the biological materials. In another aspect, a need exists for microbe-containing compositions that remain stable and active before and after application to plants, plant parts or seeds.

### BRIEF SUMMARY

This section provides a general summary of the disclosure and is not a comprehensive disclosure of its full scope or all of its features.

New and useful encapsulated microbial compositions and methods of making the same are set forth in the appended claims. Illustrative embodiments are also provided to enable a person skilled in the art to make and use the claimed subject matter.

In one aspect, a method for preparing an encapsulated microbial composition is described. The method generally includes combining a microbe and at least one hydrogel to form a precursor mixture, solidifying the precursor mixture with a cross-linking agent to form an intermediate microbial composition, and drying the intermediate microbial composition to form the encapsulated microbial composition. The encapsulated microbial composition can have a water content less than or equal to about 10% or less than or equal to about 5%. The at least one hydrogel generally includes an alginate, and the cross-linking agent generally includes a divalent cation, a divalent cation salt, or a combination thereof. The drying can be performed at a drying temperature of greater than or equal to about 15° C. with an evaporation rate of less than or equal to about 25,000 g/hr/m².

In another aspect, a method for preparing an encapsulated microbial composition is described. The method generally includes combining a microbe and at least one hydrogel to form a precursor mixture, solidifying the precursor mixture with a cross-linking agent to form an intermediate microbial composition, and drying the intermediate microbial composition to form the encapsulated microbial composition. The at least one hydrogel generally includes an alginate, and the cross-linking agent generally includes a divalent cation, a divalent cation salt, or a combination thereof. The encapsulated microbial composition can have a tapped density of greater than or equal to about 0.5 g/mL to less than or equal to about 1.5 g/mL.

The alginate may be selected from the group consisting of sodium alginate, potassium alginate, barium alginate, calcium alginate, magnesium alginate, strontium alginate, and a combination thereof.

The at least one hydrogel may further include carboxymethyl cellulose, carrageenan, cellulose acetate phthalate, chitosan and a chitosan derivative, collagen, gelatin, glycosaminoglycan, guar gum, gum acacia, hyaluronic acid, hydroxyethyl cellulose, hydroxypropyl methyl cellulose, locust bean gum, methyl cellulose, pectin, polyethylene oxides, polyglycolic acid, polyurethane, a starch, a modified starch, xanthan gum, or a combination thereof.

The at least one hydrogel may be present in the precursor mixture in an amount of about 5 wt % to about 50 wt %, based on total weight of the precursor mixture.

The precursor mixture may include a nitrogen-containing stabilizer, a sugar-containing stabilizer, or a combination thereof. Examples of the nitrogen-containing stabilizer include ammonia, ammonium hydroxide, urea, ammonium phosphate, ammonium sulfate, ammonium pyrophosphate, ammonium chloride, gluten, hydrolyzed casein, hydrolyzed whey protein, hydrolyzed pea protein, hydrolyzed soy protein, malt extract, milk powder, whey powder, yeast extract, and a combination thereof. Examples of the sugar-containing stabilizer a disaccharide, a sugar alcohol, or a combination thereof. For example, the sugar-containing stabilizer may be selected from the group consisting of mannitol, sorbitol, xylitol, trehalose, sucrose, lactose, and a combination thereof.

The nitrogen-containing stabilizer and the sugar-containing stabilizer each may be present in the precursor mixture in an amount of about 5 wt % to about 50 wt %, based on total weight of the precursor mixture.

The microbe may be a non-spore-forming bacteria. For example, the microbe may be selected from the group consisting of Pseudomonas (e.g., Pseudomonas fluorescens), Bradyrhizobium (e.g., Bradyrhizobium japonicum), Herbaspirillum (e.g., Herbaspirillum frisingense, Herbaspirillum seropedicae, Herbaspirillum rubrisubalbicans, etc.), Phytobacter (e.g., Phytobacter diazotrophicus, Phytobacter ursingii, Phytobacter palmae, etc.), Pseudacidovorax (e.g., Pseudacidovorax intermedius), Mitsuaria, Azospirillum, Burkholderia, Chryseomonas, Aeromonas, Acinetobacter, Stenotrophomonas, Chromobacterium, Agrobacterium, Chryseobacterium, Xenorhabdus, Photorhabdus, and a combination thereof.

The precursor mixture may further include a filler, such as a starch, a cellulose, biochar, pumice, silica, clay, a zeolite, perlite, or a combination thereof.

The filler may be present in the precursor mixture in an amount of about 0.1 wt % to about 90 wt %, based on total weight of the precursor mixture.

The divalent cation may be a barium cation, a calcium cation, a magnesium cation, a strontium cation, a cobalt cation, a nickel cation, a zinc cation, a manganese cation, or a combination thereof. The divalent cation salt may be a barium salt, a calcium salt, a magnesium salt, a strontium salt, a cobalt salt, a zinc salt, a manganese salt, or a combination thereof.

The cross-linking agent may further include a solvent.

The solidifying may include contacting droplets of the precursor mixture with the cross-linking agent to form the intermediate microbial composition in a form of cross-linked beads, for example, having an average particle diameter of about 1 mm to about 20 mm.

Additionally or alternatively, the solidifying may include flowing the precursor mixture through an aperture having a diameter, for example, about 100 μm to about 500 μm, and contacting the precursor mixture with the cross-linking agent to form the intermediate microbial composition in a form of cross-linked microbeads, for example, having an average particle diameter of about 100 μm to about 20 mm.

The divalent cation may be present in an amount of about 0.1% to 10% of the total dry weight of the encapsulated microbial composition.

Additionally or alternatively, the solidifying may include high shear mixing of the precursor mixture with the cross-linking agent. For example, the high shear mixing may be performed with a tip speed of at least about 3.5 m/s (e.g., about 3.5 m/s to about 25 m/s) for at least about 5 seconds (e.g., about 5 seconds to about 20 minutes) and at a temperature of about 4° C. to about 30° C.

Additionally or alternatively, the solidifying may include combining the precursor mixture with the cross-linking agent to form the intermediate microbial composition, wherein the cross-linking agent includes the divalent cation salt and the divalent cation salt is a divalent cation carbonate, such as barium carbonate, calcium carbonate, magnesium carbonate, strontium carbonate, cobalt carbonate, nickel carbonate, zinc carbonate, manganese carbonate, or a combination thereof, in particular, calcium carbonate. The divalent cation may be present in an amount equivalent to about 0.001% to about 25% of the total dry weight of the encapsulated microbial composition.

The solidifying may further include adding an acidic buffer. For example, the acidic buffer may be added: (i) to the precursor mixture and/or the cross-linking agent before the cross-linking agent is combined with the precursor mixture; (ii) to the precursor mixture substantially simultaneously along with the cross-linking agent; (iii) to a mixture comprising the precursor mixture and the cross-linking agent; or any combination of (i), (ii), and (iii). The mixture may have a pH of about 4 to about 6.5.

The combining may be performed for greater than or equal to about 5 minutes (e.g., about 5 minutes to about 48 hours) and/or at a temperature greater than or equal to about 4° C. (e.g., about 4° C. to about 40° C.).

The combining may include mixing the precursor mixture with the cross-linking agent.

The method may further include applying the intermediate microbial composition to a substrate, for example, the intermediate microbial composition is in a form a film on the substrate. The film may have a thickness of about 1 mm to about 1 cm.

In the method, the drying temperature may be about 15° C. to about 60° C. and/or a drying time may be greater than or equal to about 15 minutes (e.g., about 15 minutes to about 200 hours).

The evaporation rate may be less than or equal to about 15,000 g/hr/m², less than or equal to about 10,000 g/hr/m², less than or equal to about 5,000 g/hr/m², or about 1 g/hr/m² to about 500 g/hr/m², about 50 g/hr/m² to about 500 g/hr/m², about 1 g/hr/m² to about 250 g/hr/m² or about 1 g/hr/m² to about 100 g/hr/m²

The method may further include processing the encapsulated microbial composition to form encapsulated microbial particles and/or reducing the size of the encapsulated microbial particles, e.g., via milling the encapsulated microbial particles, to have an average particle diameter of less than or equal to about 200 μm.

The encapsulated microbial composition may have less than two logs loss or less than one log loss of colony forming unit per gram (CFU/g) after 4 weeks, 8 weeks, or 12 weeks at 25° C. and 65% relative humidity (RH).

The method may further include applying the encapsulated microbial composition to one or more of: a plant seed, a plant, a part of a plant, and a plant environment. The plant seed may further include a protectant agent, an herbicide, a pesticide, a fungicide, or a combination thereof. Examples of the plant seed include a vegetable seed, a fruit seed, a grain seed, and a combination thereof.

The method may further include combining at least one hydrophobic additive with the microbe and the at least one hydrogel to form the precursor mixture.

The method may further include drying the intermediate microbial composition to form the encapsulated microbial composition by one or more of air drying the intermediate microbial composition, vacuum drying the intermediate microbial composition, and/or drying the intermediate microbial composition in a fluid bed.

In a further aspect, another method for preparing an encapsulated microbial composition is described. The method generally includes combining a microbe and at least one hydrogel to form a precursor mixture, solidifying the precursor mixture with a cross-linking agent to form an intermediate microbial composition in a form of cross-linked beads, and drying the intermediate microbial composition to form the encapsulated microbial composition. The solidifying generally includes contacting droplets of the precursor mixture with the cross-linking agent. The encapsulated microbial composition can have a water content less than or equal to about 10%. The at least one hydrogel generally includes an alginate, and the cross-linking agent generally includes a divalent cation, a divalent cation salt, or a combination thereof.

In a further aspect, another method for preparing an encapsulated microbial composition is described. The method generally includes combining a microbe and at least one hydrogel to form a precursor mixture, solidifying the precursor mixture with a cross-linking agent to form an intermediate microbial composition in a form of cross-linked microbeads, and drying the intermediate microbial composition to form the encapsulated microbial composition. The solidifying generally includes flowing the precursor mixture through an aperture having a diameter of about 100 μm to about 500 μm and contacting the precursor mixture with the cross-linking agent. The encapsulated microbial composition can have a water content less than or equal to about 10%. The at least one hydrogel generally includes an alginate, and the cross-linking agent generally includes a divalent cation, a divalent cation salt, or a combination thereof.

In a further aspect, another method for preparing an encapsulated microbial composition is described. The method generally includes combining a microbe and at least one hydrogel to form a precursor mixture, solidifying the precursor mixture with a cross-linking agent to form an intermediate microbial composition, and drying the intermediate microbial composition to form the encapsulated microbial composition. The solidifying generally includes high shear mixing of the precursor mixture with the cross-linking agent. The encapsulated microbial composition can have a water content less than or equal to about 10%. The at least one hydrogel generally includes an alginate, and the cross-linking agent generally includes a divalent cation, a divalent cation salt, or a combination thereof.

In a further aspect, another method for preparing an encapsulated microbial composition is described. The method generally includes combining a microbe and at least one hydrogel including an alginate to form a precursor mixture, solidifying the precursor mixture with a cross-linking agent including a divalent cation salt to form an intermediate microbial composition, and drying the intermediate microbial composition to form the encapsulated microbial composition. The solidifying generally includes combining the precursor mixture with the cross-linking agent, and the divalent cation salt can be a divalent cation carbonate. The encapsulated microbial composition can have a water content less than or equal to about 10%.

In another aspect, an encapsulated microbial composition is described. The encapsulated microbial composition generally includes a microbe embedded in a polymeric matrix including at least one hydrogel bonded together with a divalent cation. The at least one hydrogel generally includes an alginate. The encapsulated microbial particle composition can have a water content of less than or equal to about 10% or less than or equal to about 5%.

In another aspect, an encapsulated microbial composition is described. The encapsulated microbial composition generally includes a microbe embedded in a polymeric matrix including at least one hydrogel bonded together with a divalent cation. The at least one hydrogel generally includes an alginate. The encapsulated microbial particle composition can have a tapped density of greater than or equal to about 0.5 g/mL to less than or equal to about 1.5 g/mL.

The alginate may be selected from the group consisting of sodium alginate, potassium alginate, barium alginate, calcium alginate, magnesium alginate, strontium alginate, and a combination thereof.

The at least one hydrogel may further include carboxymethyl cellulose, carrageenan, cellulose acetate phthalate, chitosan and a chitosan derivative, collagen, gelatin, glycosaminoglycan, guar gum, gum acacia, hyaluronic acid, hydroxyethyl cellulose, hydroxypropyl methyl cellulose, locust bean gum, methyl cellulose, pectin, polyethylene oxides, polyglycolic acid, polyurethane, a starch, a modified starch, xanthan gum, or a combination thereof.

The at least one hydrogel may be present in the composition in an amount of about 5 wt % to about 50 wt %, based on total weight of the composition.

The polymeric matrix may further include a nitrogen-containing stabilizer, a sugar-containing stabilizer, or a combination thereof. Examples of the nitrogen-containing stabilizer include ammonia, ammonium hydroxide, urea, ammonium phosphate, ammonium sulfate, ammonium pyrophosphate, ammonium chloride, gluten, hydrolyzed casein, hydrolyzed whey protein, hydrolyzed pea protein, hydrolyzed soy protein, malt extract, milk powder, whey powder, yeast extract, and a combination thereof. Examples of the sugar-containing stabilizer a disaccharide, a sugar alcohol, or a combination thereof. For example, the sugar-containing stabilizer may be selected from the group consisting of mannitol, sorbitol, xylitol, trehalose, sucrose, lactose, and a combination thereof.

The nitrogen-containing stabilizer and the sugar-containing stabilizer each may be present in the composition in an amount of about 5 wt % to about 50 wt %, based on total weight of the composition.

The microbe may be a non-spore-forming bacteria. For example, the microbe may be selected from the group consisting of Pseudomonas (e.g., Pseudomonas fluorescens), Bradyrhizobium (e.g., Bradyrhizobium japonicum), Herbaspirillum (e.g., Herbaspirillum frisingense, Herbaspirillum seropedicae, Herbaspirillum rubrisubalbicans, etc.), Phytobacter (e.g., Phytobacter diazotrophicus, Phytobacter ursingii, Phytobacter palmae, etc.), Pseudacidovorax (e.g., Pseudacidovorax intermedius), Mitsuaria, Azospirillum, Burkholderia, Chryseomonas, Aeromonas, Acinetobacter, Stenotrophomonas, Chromobacterium, Agrobacterium, Chryseobacterium, Xenorhabdus, Photorhabdus, and a combination thereof.

The polymeric matrix may further include a filler, such as a starch, a cellulose, biochar, pumice, silica, clay, a zeolite, perlite, or a combination thereof.

The filler may be present in the composition in an amount of about 0.1 wt % to about 90 wt %, based on total weight of composition.

The divalent cation may be a barium cation, a calcium cation, a magnesium cation, a strontium cation, a cobalt cation, a nickel cation, a zinc cation, a manganese cation, or a combination thereof.

The encapsulated microbial composition may be in a form of particles, for example, having a particle diameter of less than or equal to about 300 μm.

The encapsulated microbial composition may have less than two logs loss or less than one log loss of colony forming unit per gram (CFU/g) after 4 weeks, 8 weeks or 12 weeks at 25° C. and 65% relative humidity (RH).

The polymeric matrix may further include at least one hydrophobic additive.

In another aspect, a seed composition is described. The seed composition generally includes a plant seed and an encapsulated microbial composition as described herein present on at least a portion of a surface of the plant seed. Examples of the plant seed include a vegetable seed, a fruit seed, a grain seed, and a combination thereof. Additional examples of the plant seed include a canola seed, a corn seed, a soybean seed, a wheat seed, and a combination thereof.

The plant see may further include a protectant agent, an herbicide, a pesticide, a fungicide, or a combination thereof.

The seed composition may further include a hydrophobic coating.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 shows the on-seed stability of alginate-encapsulated Pseudomonas fluorescens beads at 25° C. and 65% relative humidity (RH);

FIG. 2 shows the on-seed stability alginate-encapsulated Pseudomonas fluorescens beads at 10° C. and 50% RH;

FIG. 3 shows the microbial powder (off-seed) stability of alginate-encapsulated Pseudomonas fluorescens beads at 25° C.;

FIG. 4 shows the on-seed stability of alginate-encapsulated Bradyrhizobium japonicum beads at 25° C. and 65% RH;

FIG. 5 shows the on-seed stability of alginate-encapsulated Bradyrhizobium japonicum beads at 10° C. and 50% RH;

FIG. 6 shows the on-seed stability of alginate-encapsulated Pseudomonas fluorescens prepared via the shear-mix method with varying calcium chloride concentrations at 25° C. and 65% RH;

FIG. 7 shows the on-seed stability of alginate-encapsulated Pseudomonas fluorescens prepared via the shear-mixed method with additional hydrogel or biochar at 25° C. and 65% RH;

FIG. 8 shows the average CFU/g after 24 hours and 96 hours incubation at different soil moisture concentrations;

FIG. 9 shows dynamic vapor sorption (DVS) data for different crosslinked alginate preparations containing Pseudomonas fluorescens;

FIG. 10 shows impact of alginate encapsulation on stability for Herbaspirillum frisingense;

FIG. 11 shows impact of alginate encapsulation on stability for Pseudacidovorax intermedius;

FIG. 12 shows dynamic vapor sorption (DVS) data for alginate-encapsulated Phytobacter diazotrophicus, with different additives included therein;

FIG. 13 shows impact of alginate encapsulation with different additives on stability for Phytobacter diazotrophicus;

FIG. 14 shows dynamic vapor sorption (DVS) data for alginate-encapsulated Pseudomonas fluorescens, with a hydrophobic coating; and

FIG. 15 shows dynamic vapor sorption (DVS) data for alginate-encapsulated Bradyrhizobium japonicum, with a hydrophobic coating.

### DETAILED DESCRIPTION OF EXAMPLE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting. That said, example embodiments will now be described more fully with reference to the accompanying drawings.

Encapsulated microbial compositions with increased stability, which, for example, can be applied to a plant seed to promote growth and/or provide pest control, and methods for preparing such encapsulated microbial compositions with increased stability are described herein. The compositions can include a microbe, for example, a non-spore forming bacteria, embedded in a polymeric matrix including at least one hydrogel, such as an alginate, bonded together with a divalent cation. The compositions can have a generally (or relatively) lower water content, for example, less than about 10%; generally (or relatively) increased tapped densities, for example, from about 0.5 g/mL to about 1.5 g/mL; and/or average particle diameters of about 200 μm or less (e.g., including about 150 μm or less, about 100 μm or less, etc.); etc. Typically, encapsulated microbial compositions have been made by processes including a fast drying step, such as a spray drying step. However, these previous compositions have difficulty maintaining long term storage stability. It has been surprisingly discovered that encapsulated microbial compositions with increased stability can be achieved via methods described herein which include a slower drying step, for example, by utilizing a slower evaporation rate at a lower temperature as more fully discussed below.

### I. Encapsulated Microbial Compositions

Encapsulated microbial compositions are provided herein. The compositions can include a microbe embedded in a polymeric matrix comprising at least one hydrogel bonded together with a divalent cation. The compositions advantageously have a lower water content and increased stability for rendering them more suitable for long-term storage, for example, for plant seed applications and treatments.

In any embodiment, the encapsulated microbial compositions may be formed apart from seeds (or off seed) and stored, for example, as a powder, etc., prior to application to the seeds (e.g., as part of a seed treatment for the seeds, etc.) For example, in powder form, the microbial composition may be applied as a dry powder or as a powder dispersed in a suitable solvent, e.g., a water miscible solvent, such as, polyethylene glycol and the like. Alternatively, in any embodiment, the encapsulated microbial compositions may be applied directly to and/or formed on seeds, for example, as an on-seed treatment.

### A. Microbes

The term “microbe” refers to any species or type of microorganism, including but not limited to bacteria, archaea, viruses, fungi, prions, protozoa, algae, and parasites. The term “microbe” as used herein is intended to encompass both individual microorganisms and combinations or preparations including any number of microorganisms. The terms “microbe” and “microorganism” are interchangeably used herein. The terms “bacteria” and “bacterium” refer to unicellular prokaryote microorganisms. The term is intended to encompass all microorganisms that are considered bacteria, including mycoplasma. All forms of bacteria are encompassed herein, including cocci, bacilli, spirochetes, spheroplasts, protoplasts, and the like. The term also includes gram-negative and gram-positive bacteria as well as spore-forming bacteria and non-spore-forming bacteria. The terms “fungus” or “fungi” refer to eukaryotic microorganisms from the kingdom Fungi, such as molds, yeasts, and mushrooms.

In any embodiment, the microbe may be a non-spore-forming bacteria, a spore-forming bacteria, including vegetative cells of a spore-forming bacteria, a fungus, or a combination thereof. For example, in any embodiment, a microbe herein may include vegetative cells of any bacteria, fungus, or combination thereof. Further, the microbe may be vegetative cells of a spore-forming bacteria, where the spore-forming bacteria has been cultured in a way that leads to complete lack of or partial sporulation, such that the cultured cells that are formulated are all or partially vegetative cells.

Examples of bacterial microbes include, but are not limited to bacteria of the following genera: Achromobacter, Acinetobacter, Aeromonas, Agrobacterium, Ampelomyces, Aureobasidium, Azospirillum, Azotobacter, Bacillus, Beauveria, Bradyrhizobium, Burkholderia, Candida, Chaetomium, Chromobacterium, Chryseobacterium, Chryseomonas, Cordyceps, Cryptococcus, Dabaryomyces, Delftia, Erwinia, Exophilia, Gliocladium, Herbaspirillum, Lactobacillus, Mariannaea, Microccocus, Mitsuaria, Paecilomyces, Paenibacillus, Pantoea, Photorhabdus, Phytobacter, Pichia, Pseudomonas, Pseudacidovorax, Rhizobium, Saccharomyces, Sporobolomyces, Stenotrophomonas, Streptomyces, Talaromyces, Trichoderma, Xenorhabdus, and combinations thereof. For example, the microbe may be bacteria selected from the group consisting of Pseudomonas, Bradyrhizobium, Herbaspirillum, Phytobacter, Pseudacidovorax, Mitsuaria, Azospirillum, Burkholderia, Chryseomonas, Aeromonas, Acinetobacter, Stenotrophomonas, Chromobacterium, Agrobacterium, Chryseobacterium Xenorhabdus, Photorhabdus, and combinations thereof.

In any embodiment, the microbe may be a bacterium belonging to the Pseudomonas genus, the Bradyrhizobium genus, the Phytobacter genus, or a combination thereof. Examples of Pseudomonas species include, but are not limited to, species of the Pseudomonas aeruginosa group (e.g., P. aeruginosa, P. alcaligenes, P. anguilliseptica, etc.), the Pseudomonas chloroaphis group (e.g., P. aurantiaca, P. aureofaciens, P. chlororaphis, etc.), the Pseudomonas fluorescens group (e.g., P. azotoformans, P. fluoroscens, P. migulae, etc.), the Pseudomonas pertucinogena group (e.g., P. denitrificans, P. pertucinogena), the Pseudomonas putida group (e.g., P. cremoricolorata, P. entomophila, P. fulva, etc.), the Pseudomonas stutzeri group (e.g., P. balearica, P. luteola, P. stutzeri), the Pseudomonas syringae group (e.g., P. amygdali, P. avellanae, P. caricapapayae), and combinations thereof. Examples of Bradyrhizobium species include, but are not limited to, Bradyrhizobium arachidis Bradyrhizobium betae, Bradyrhizobium canariense, Bradyrhizobium diazoefficiens, Bradyrhizobium erythrophlei, Bradyrhizobium ferriligni, Bradyrhizobium icense, Bradyrhizobium ingae, Bradyrhizobium japonicum, Bradyrhizobium kavangense, Bradyrhizobium oligotrophicum, Bradyrhizobium retamae, Bradyrhizobium viridifuturi, and combinations thereof. Examples of Phytobacter species include, but are not limited to, species of the Phytobacter diazotrophicus, Phytobacter ursingii, Phytobacter palmae, Phytobacter massilienses, and combinations thereof. Examples of the Herbaspirillum species include, but are not limited to, species of the Herbaspirillum frisingense, Herbaspirillum seropedicae, Herbaspirillum rubrisubalbicans, and combinations thereof. In some embodiments, the microbe may be Pseudomonas fluorescens, Bradyrhizobium japonicum, Phytobacter diazotrophicus, Herbaspirillum frisingense, or a combination thereof.

Additionally or alternatively, the microbe may be a fungus. Examples of fungi include, but are not limited to, Muscodor species, Aschersonia aleyrodis, Beauveria bassiana (“white muscarine”), Beauveria brongniartii, Chladosporium herbarum, Cordyceps clavulata, Cordyceps entomorrhiza, Cordyceps facis, Cordyceps gracilis, Cordyceps melolanthae, Cordyceps militaris, Cordyceps myrmecophila, Cordyceps ravenelii, Cordyceps sinensis, Cordyceps sphecocephala, Cordyceps subsessilis, Cordyceps unilateralis, Cordyceps variabilis, Cordyceps washingtonensis, Culicinomyces clavosporus, Entomophaga grylli, Entomophaga maimaiga, Entomophaga muscae, Entomophaga praxibulli, Entomophthora plutellae, Fusarium lateritium, Hirsutella citriformis, Hirsutella thompsoni, Metarhizium anisopliae (“green muscarine”), Metarhizium flaviride, Muscodor albus, Neozygites floridana, Nomuraea rileyi, Paecilomyces farinosus, Paecilomyces fumosoroseus, Pandora neoaphidis, Tolypocladium cylindrosporum, Verticillium lecanii, Zoophthora radicans, mycorrhizal species, such as Laccaria bicolor, and combinations thereof.

### B. Hydrogels

In various aspects, the at least one hydrogel can include a hydrophilic polymer, a polysaccharide, a gum, a resin, a hydrolyzed protein, or a combination thereof. Examples of suitable hydrogels include, but are not limited to, an alginate, carboxymethyl cellulose, carrageenan, cellulose acetate phthalate, chitosan and chitosan derivatives, collagen, gelatin, glycosaminoglycan, guar gum, gum acacia, hyaluronic acid, hydroxyethyl cellulose, hydroxypropyl methyl cellulose, locust bean gum, methyl cellulose, pectin, a polyethylene oxide, polyglycolic acid, polyurethane, a starch, a modified starch, xanthan gum, or a combination thereof.

In any embodiment, the at least one hydrogel can comprise an alginate. For example, the alginate may be selected from the group consisting of sodium alginate, potassium alginate, barium alginate, calcium alginate, magnesium alginate, strontium alginate, and a combination thereof.

In any embodiment, the at least one hydrogel can include an alginate as described herein as well as a further hydrogel selected from the group consisting of carboxymethyl cellulose, carrageenan, cellulose acetate phthalate, chitosan and chitosan derivatives, collagen, gelatin, glycosaminoglycan, guar gum, gum acacia, hyaluronic acid, hydroxyethyl cellulose, hydroxypropyl methyl cellulose, locust bean gum, methyl cellulose, pectin, a polyethylene oxide, polyglycolic acid, polyurethane, a starch, a modified starch, xanthan gum, and a combination thereof.

The at least one hydrogel may be present in the composition in an amount, based on total weight of the composition, of greater than or equal to about 2.5 wt %, greater than or equal to about 5 wt %, greater than or equal to about 10 wt %, greater than or equal to about 20 wt %, less than or equal to about 60 wt %, less than or equal to about 50 wt %, less than or equal to about 40 wt %, or less than or equal to about 30 wt %, or from about 5 wt % to about 60 wt %, about 5 wt % to about 50 wt %, about 5 wt % to about 40 wt %, about 5 wt % to about 30 wt %, about 5 wt % and about 20 wt %, about 10 wt % to about 60 wt %, about 10 wt % to about 50 wt %, about 10 wt % to about 40 wt %, about 10 wt % to about 30 wt %, or about 10 wt % and about 20 wt %, etc. In any embodiment, the at least one hydrogel may be present in the composition in amount, based on total weight of the composition, for example, from about 5 wt % to about 50 wt %.

### C. Divalent Cations

Suitable divalent cations include metallic divalent cations capable of cross-linking the hydrogel. Non-limiting examples of suitable divalent cation include a barium (Ba²⁺) cation, a calcium (Ca²⁺) cation, a magnesium (Mg²⁺) cation, a strontium (Sr²⁺) cation, a cobalt (Co²⁺) cation, a nickel (Ni²⁺) cation, a zinc (Zn²⁺) cation, a manganese (Mn²⁺) cation, and combinations thereof. In any embodiment, the divalent cation may, for example, be a calcium cation.

### D. Stabilizers

In any embodiment, the polymeric matrix may further include one or more stabilizers. For example, the stabilizer may be a nitrogen-containing stabilizer, a sugar-containing stabilizer, or a combination thereof.

Examples of suitable nitrogen-containing stabilizers include, but are not limited to, ammonia, ammonium hydroxide, urea, ammonium phosphate, ammonium sulfate, ammonium pyrophosphate, ammonium chloride, gluten, hydrolyzed casein, hydrolyzed whey protein, hydrolyzed pea protein, hydrolyzed soy protein, malt extract, milk powder, whey powder, yeast extract, and combinations thereof.

Examples of suitable sugar-containing stabilizers include, but are not limited to, a disaccharide, a sugar alcohol, and a combination thereof. For example, the sugar-containing stabilizer may be selected from the group consisting of mannitol, sorbitol, xylitol, trehalose, sucrose, lactose, and a combination thereof.

The stabilizer, e.g., the nitrogen-containing stabilizer and the sugar-containing stabilizer, singularly or in combination, can be present in the composition in an amount, based on total weight of the composition, of greater than or equal to about 2.5 wt %, greater than or equal to about 5 wt %, greater than or equal to about 10 wt %, greater than or equal to about 20 wt %, less than or equal to about 60 wt %, less than or equal to about 50 wt %, less than or equal to about 40 wt %, or less than or equal to about 30 wt %, or from about 5 wt % to about 60 wt %, about 5 wt % to about 50 wt %, about 5 wt % to about 40 wt %, about 5 wt % to about 30 wt %, about 5 wt % and about 20 wt %, about 10 wt % to about 60 wt %, about 10 wt % to about 50 wt %, about 10 wt % to about 40 wt %, about 10 wt % to about 30 wt %, or about 10 wt % and about 20 wt %, etc. In any embodiment, the nitrogen-containing stabilizer and the sugar-containing stabilizer, singularly or in combination, may be present in the composition in amount(s), based on total weight of the composition, for example, from about 5 wt % to about 50 wt %.

### E. Additional Components

In any embodiment, the polymeric matrix may further include a filler (also referred to as an inert carrier). Examples of fillers may include, but are not limited to, a starch, a modified starch, maltodextrin, gum, diatomaceous earth, loam, a cellulose, biochar, pumice, silica, silicates, talc, kaolins, limestone, line, chalk, clay (e.g., mectites, hectorites, bentonites, montmorillonites, celites, illites and combinations thereof), dolomite, a zeolite, perlite, and combinations thereof. In any embodiment, the filler may include biochar. The term “biochar” refers to a carbonaceous solid formed from pyrolysis of biomass under anoxic or anaerobic conditions.

A filler can be present in the composition in an amount, based on total weight of the composition, greater than or equal to about 0.1 wt %, greater than or equal to about 1 wt %, greater than or equal to about 2.5 wt %, greater than or equal to about 5 wt %, greater than or equal to about 10 wt %, greater than or equal to about 20 wt %, greater than or equal to about 30 wt %, greater than or equal to about 40 wt %, greater than or equal to about 50 wt %, less than or equal to about 95 wt %, less than or equal to about 90 wt %, less than or equal to about 80 wt %, less than or equal to about 70 wt %, or less than or equal to about 60 wt %, or from about 0.1 wt % to about 95 wt %, about 0.1 wt % to about 90 wt %, about 0.1 wt % to about 80 wt %, about 0.1 wt % to about 70 wt %, about 0.1 wt % to about 60 wt %, about 0.1 wt % to about 50 wt %, about 0.1 wt % to about 40 wt %, about 0.1 wt % to about 30 wt %, about 0.1 wt % to about 20 wt %, about 0.1 wt % to about 10 wt %, about 0.1 wt % to about 5 wt %, about 0.1 wt % to about 2.5 wt %, about 10 wt % to about 95 wt %, about 10 wt % to about 90 wt %, about 10 wt % to about 80 wt %, about 10 wt % to about 70 wt %, about 10 wt % to about 60 wt %, about 10 wt % to about 50 wt %, about 10 wt % to about 40 wt %, about 10 wt % to about 30 wt %, about 10 wt % to about 20 wt %, about 50 wt % to about 95 wt %, about 50 wt % to about 90 wt %, about 50 wt % to about 80 wt %, about 50 wt % to about 70 wt %, or about 50 wt % to about 60 wt %, etc. In any embodiment, a filler may be present in the composition in amount, based on total weight of the composition, for example, from about 0.1 wt % to about 90 wt %.

Additionally or alternatively, the composition may optionally include one or more additional component (or additive), such as, but not limited to, surfactants, dispersants, emulsifiers, wetters, adjuvants, solubilizers, penetration enhancers, protective colloids, adhesion agents, thickeners, humectants, repellents, attractants, feeding stimulants, compatibilizers, anti-freezing agents, anti-foaming agents, colorants, tackifiers, binders, and/or hydrophobic additives. In particular, in any embodiment, the additional component may include one or more hydrophobic additive, wherein the composition may therefore include one or more hydrophobic additive that is/are hydrophobic, water soluble and/or dispersible, microbe compatible, film forming, and/or a moisture barrier when dry, etc. In such embodiment(s), the one or more hydrophobic additive may include, for example, a silk fibroin solution, a wax-based dispersion, a dispersion of ethylcellulose or other modified celluloses, an alkalized shellac solution, a modified chitosan solution, polyvinyl alcohol, a modified acrylate- or methacrylate-based solution, or combinations thereof. In addition, in such embodiment(s), the one or more hydrophobic additive may enhance, extend, etc. on-seed stability of the composition (e.g., by reducing, limiting, inhibit, etc. moisture uptake by the matrix of the composition, etc.)

### F. Composition Properties

As described above, the compositions can advantageously exhibit increased stability. For example, the composition's increased stability can be demonstrated by the sustained viability of the microbe present in the composition after an extended period of time, for example, at an increased temperature and higher relative humidity (RH). This sustained viability of the microbe in the compositions can be demonstrated by a minimal loss of microbe colony forming unit per gram (CFU/g) after a period of time at a range of temperatures and relative humidity, for example, once the composition is applied to a seed, a plant, or part of a plant. For example, the encapsulated microbial compositions can exhibit less than or equal to about four logs loss of CFU/g, less than or equal to about three logs loss of CFU/g, less than or equal to about two logs loss of CFU/g, or less than or equal to about one log loss of CFU/g. This measured loss of microbe CFU/g may be measured at and/or may occur at about 1 week, after about 4 weeks, after about 6 weeks, after about 8 weeks, after about 10 weeks, after about 12 weeks, after about 16 weeks, after about 20 weeks, or after about 24 weeks from application of the composition onto a seed, a plant, or part of a plant, or between about 1 week to about 24 weeks, about 1 week to about 20 weeks, about 1 week to about 16 weeks, about 1 week to about 12 weeks, about 1 week to about 8 weeks, about 1 week to about 4 weeks, about 4 weeks to about 24 weeks, about 4 weeks to about 20 weeks, about 4 weeks to about 16 weeks, about 4 weeks to about 12 weeks, or about 4 weeks to about 8 weeks, etc. Additionally or alternatively, this measured loss of microbe CFU/g may be measured at and/or may occur at a temperature (e.g., an ambient temperature, a composition temperature, etc.) of greater than equal to about 15° C., greater than equal to about 20° C., greater than equal to about 25° C., less than or equal to about 40° C., less than equal to about 35° C., or less than equal to about 30° C., or from about 15° C. to about 40° C., about 15° C. to about 35° C., about 15° C. to about 30° C., about 15° C. to about 25° C., or about 15° C. to about 20° C., etc. Additionally or alternatively, this measured loss of microbe CFU/g may be measured at and/or may occur at a RH of greater than or equal to about 50%, greater than or equal to about 60%, greater than or equal to about 65%, less than or equal to about 90%, less than or equal to about 80%, less than or equal to about 70%, or from about 50% to about 90%, about 50% to about 80%, about 50% to about 70%, or about 50% to about 65%, etc. In particular, the encapsulated microbial composition may have less than two logs or less than one log loss of colony forming unit per gram (CFU/g) after 4 weeks, 8 weeks or 12 weeks at 25° C. and 65% relative humidity (RH).

Additionally, the compositions may have a lower water content. For example, the compositions may have a water content of less than or equal to about 25%, less than or equal to about 20%, less than or equal to about 15%, less than or equal to about 10%, less than or equal to about 5%, less than our equal to about 1%, or about 0.1%, or from about 0.1% to about 25%, about 0.1% to about 20%, about 0.1% to about 15%, about 0.1% to about 10%, about 0.1% to about 5%, or about 0.1% to about 1%, etc. Water content of the composition may be measured using an infrared (IR) moisture analyzer. For example, to measure moisture content of a sample, the sample's start weight may be recorded, afterwards a halogen lamp or other infrared radiator may heat and dry the sample while an integrated balance continually records the sample weight. When the sample no longer loses weight the IR moisture analyzer shuts off and the moisture content can be calculated based on the total loss in weight as understood by a person of ordinary skill in the art.

In any embodiment, the composition may be present as particles having an average particle diameter of greater than or equal to about 1 μm, greater than or equal to about 10 μm, greater than or equal to about 25 μm, greater than or equal to about 50 μm, greater than or equal to about 100 μm, greater than or equal to about 150 μm, greater than or equal to about 200 μm, greater than or equal to about 250 μm, greater than or equal to about 300 μm, less than or equal to about 20 mm, less than or equal to about 1 mm, less than or equal to about 500 μm, less than or equal to about 300 μm, or less than or equal to about 200 μm, less than or equal to about 100 μm, less than or equal to about 75 μm, less than or equal to about 50 μm, less than or equal to about 25 μm, less than or equal to about 10 μm, less than or equal to about 5 μm, or from about 25 μm to about 20 mm, about 25 μm to about 1 mm, about 25 μm to about 500 μm, about 25 μm to about 300 μm, about 25 μm to about 200 μm, about 25 μm to about 150 μm, about 25 μm to about 100 μm, about 25 μm to about 50 μm, about 50 μm to about 300 μm, about 50 μm to about 200 μm, about 50 μm to about 150 μm, about 50 μm to about 100 μm, etc.

In any embodiment, the composition may include greater than or equal to about 1×10⁸ CFU/gram, greater than or equal to about 3×10⁸ CFU/gram, greater than or equal to about 5×10⁸ CFU/gram, greater than or equal to about 8×10⁸ CFU/gram, greater than or equal to about 1×10⁹ CFU/gram, less than or equal to about 1×10¹⁰ CFU/gram, less than or equal to about 8×10⁹ CFU/gram, less than or equal to about 5×10⁹, or less than or equal to about 3×10⁹ CFU/gram, or about 1×10⁸ CFU/gram to about 1×10¹⁰ CFU/gram, about 1×10⁸ CFU/gram to about 8×10⁹ CFU/gram, about 1×10⁸ CFU/gram to about 5×10⁹ CFU/gram, about 1×10⁸ CFU/gram to about 3×10⁹ CFU/gram, about 1×10⁸ CFU/gram to about 1×10⁹ CFU/gram, about 1×10⁸ CFU/gram to about 8×10⁸ CFU/gram, about 1×10⁸ CFU/gram to about 5×10⁸ CFU/gram, or about 1×10⁸ CFU/gram to about 3×10⁸ CFU/gram.

Further, the compositions may have generally (or relatively) higher tapped densities (e.g., as compared to conventionally formed compositions (e.g., compositions formed using a conventional spray-drying technique, etc.), etc.) As used herein, tapped density may refer to an increased bulk density attained after mechanically tapping a container containing the composition(s). For instance, an initial volume or mass of a composition may be determined, and a container holding the composition may then be mechanically tapped (e.g., by raising the container and composition and allowing it to drop, under its own mass, a specified distance; etc.) Additional volume or mass readings of the composition may then again be determined, after each of the tappings, until little or no (or minimal) further volume or mass change is observed. Such higher tapped densities of the compositions herein have been found to relate to, correspond to, etc. a reduction in moisture uptake of the compositions. For example, the compositions may have a tapped density of greater than or equal to about 0.5 g/mL, greater than or equal to about 0.6 g/mL, greater than or equal to about 0.7 g/mL, greater than or equal to about 0.8 g/mL, less than or equal to about 1.5 g/mL, less than or equal to about 1.4 g/mL, less than or equal to about 1.3 g/mL, less than or equal to about 1.2 g/mL, less than or equal to about 1.1 g/mL, less than or equal to about 1 g/mL, or less than or equal to about 0.9 g/mL; or greater than or equal to about 0.5 g/mL to less than or equal to about 1.5 g/mL, greater than or equal to about 0.5 g/mL to less than or equal to about 1.4 g/mL, greater than or equal to about 0.5 g/mL to less than or equal to about 1.3 g/mL, greater than or equal to about 0.5 g/mL to less than or equal to about 1.2 g/mL, greater than or equal to about 0.7 g/mL to less than or equal to about 1.5, greater than or equal to about 0.7 g/mL to less than or equal to about 1.2 g/mL, g/mL, greater than or equal to about 0.7 g/mL to less than or equal to about 1.1 g/mL, etc.

### II. Seed Compositions

Plant seed compositions are also provided herein, which include a plant seed and an encapsulated microbial composition as described herein present on at least a portion of a surface of the plant seed, for example, as a coating on the seed. In any embodiment, the encapsulated microbial compositions may be formulated as a seed treatment (or as part of a seed treatment). It is contemplated herein that the seeds can be substantially uniformly coated with one or more layers of the encapsulated microbial compositions described herein using conventional methods of mixing, spraying or a combination thereof through the use of treatment application equipment that is designed and manufactured to accurately, safely, and efficiently apply seed treatment products to seeds. Such equipment uses various types of coating technology such as rotary coaters, drum coaters, fluidized bed techniques, spouted beds, rotary mists, or a combination thereof. As such, in any embodiment, the encapsulated microbial composition may be applied to seeds, for example, in liquid form, via either a spinning “atomizer” disk or a spray nozzle (or multiple spray nozzles each associated with different components of the encapsulated microbial composition, for example, when formed on seed), which evenly distributes the composition onto the seed as it moves though the spray pattern. Preferably, the seed is then mixed or tumbled for an additional period of time to achieve additional treatment distribution and drying. The seeds may be primed or unprimed before coating with the encapsulated microbial composition to increase the uniformity of germination and emergence. In an alternative embodiment, a dry powder formulation may be metered (e.g., and applied, etc.) onto the moving seed and allowed to mix until completely distributed.

Additionally or alternatively, the plant seed and/or the seed treatment including the encapsulated microbial composition may further contain a protectant agent capable of protecting seeds from the harmful effects of selective herbicides such as activated carbon, nutrients (fertilizers), and other agents capable of improving the germination and quality of the products or a combination thereof.

A variety of additives may be added to the seed treatment formulations including the encapsulated microbial composition. Binders may be added and include those composed preferably of an adhesive polymer that can be natural or synthetic without phytotoxic effect on the seed to be coated. The binder may be selected from polyvinyl acetates, polyvinyl acetate copolymers, ethylene vinyl acetate (EVA) copolymers, polyvinyl alcohols, polyvinyl alcohol copolymers, celluloses, including ethylcelluloses, methylcelluloses, hydroxymethylcelluloses, hydroxypropylcelluloses and carboxymethylcellulose, polyvinylpyrolidones, polysaccharides, including starch, modified starch, dextrins, maltodextrins, alginate and chitosans, fats, oils, proteins, including gelatin and zeins, gum arabics, shellacs, vinylidene chloride and vinylidene chloride copolymers, calcium lignosulfonates, acrylic copolymers, polyvinylacrylates, polyethylene oxide, acrylamide polymers and copolymers, polyhydroxyethyl acrylate, methylacrylamide monomers, and polychloroprene, or from combinations thereof.

Any of a variety of colorants may be included, such as organic chromophores classified as nitroso; nitro; azo, including monoazo, bisazo and polyazo; acridine, anthraquinone, azine, diphenylmethane, indamine, indophenol, methine, oxazine, phthalocyanine, thiazine, thiazole, triarylmethane, xanthene; or combinations thereof. Other additives that may be added include trace nutrients such as salts of iron, manganese, boron, copper, cobalt, molybdenum, zinc, or combinations thereof. A polymer or other dust control agent may be applied to retain the treatment on the seed surface.

Additionally or alternatively, the coating may further comprise a layer of adherent. Examples of suitable adherents include, but are not limited to, polyvinyl acetates, polyvinyl acetate copolymers, polyvinyl alcohols, polyvinyl alcohol copolymers, celluloses, such as methyl celluloses, hydroxymethyl celluloses, and hydroxymethyl propyl celluloses, dextrins, alginates, sugars, molasses, polyvinyl pyrrolidones, polysaccharides, proteins, fats, oils, gum arabics, gelatins, syrups, starches, and combinations thereof.

Various additives, such as dispersants, surfactants, and nutrient and buffer ingredients, may also be included on the seed and/or in the seed treatment formulation. Other conventional seed treatment additives include, but are not limited to, coating agents, wetting agents, buffering agents, and polysaccharides. At least one agriculturally acceptable carrier may be added to the seed treatment formulation such as water, solids or dry powders. The dry powders may be derived from a variety of materials such as calcium carbonate, gypsum, vermiculite, talc, humus, activated charcoal, various phosphorous compounds, and/or combinations thereof.

In any embodiment, the seed and/or seed treatment formulation may comprise at least one filler which is an organic or inorganic, natural or synthetic component with which the active components are combined to facilitate its application onto the seed. Preferably, the filler is an inert solid such as clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths, or synthetic minerals, such as silica, alumina or silicates, in particular aluminum or magnesium silicates.

The seed and/or seed treatment formulation may further include one or more of the following ingredients: pesticides, including compounds that act only below the ground; fungicides, such as captan, thiram, metalaxyl, fludioxonil, oxadixyl, and isomers of each of those materials, and the like; herbicides, including compounds selected from glyphosate, carbamates, thiocarbamates, acetamides, triazines, dinitroanilines, glycerol ethers, pyridazinones, uracils, phenoxys, ureas, and benzoic acids; herbicidal safeners such as benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives; chemical fertilizers; and biological fertilizers. These ingredients may be added as a separate layer on the seed or alternatively may be added as part of the seed coating composition described herein.

Preferably, the amount of the encapsulated microbial composition or other ingredients used in the seed treatment should not inhibit germination of the seed, or cause phytotoxic damage to the seed.

The formulation that is used to treat the seed can be in the form of a suspension; emulsion; slurry of particles in an aqueous medium (e.g., water); wettable powder; wettable granules (dry flowable); and dry granules.

As mentioned above, other conventional inactive or inert ingredients may be incorporated into the formulation. Such inert ingredients may include, but are not limited to: conventional sticking agents; dispersing agents such as methylcellulose, for example, serve as combined dispersant/sticking agents for use in seed treatments, polyvinyl alcohol, lecithin, polymeric dispersants (e.g., polyvinylpyrrolidone/vinyl acetate), thickeners (e.g., clay thickeners to improve viscosity and reduce settling of particle suspensions), emulsion stabilizers; surfactants; antifreeze compounds (e.g., urea), dyes, colorants, and the like.

The microbial encapsulated compositions and coating formulations described herein may be applied to seeds by a variety of methods, including, but not limited to, mixing in a container (e.g., a bottle or bag), mechanical application, tumbling, spraying, and immersion. A variety of active or inert material can be used for contacting seeds with microbial compositions as described herein, such as conventional film-coating materials including but not limited to water-based film coating materials such as SEPIRET™ (Seppic, Inc., N.J.) and OPACOAT™ (Berwind Pharm. Services, P.A.) It is also contemplated herein that the microbial encapsulated compositions and coating formulations described herein can be applied to a plant, a part of a plant, a plant environment, or combinations thereof. For example, a seed may be coated with a polymer-based or sugar-based binder and the dried encapsulated microbial composition may be applied to the seed. The seed(s) and dried encapsulated microbial composition, e.g., in powder form, may be mixed in a seed treater for at least about 1 minute to ensure even distribution.

The amount of a composition that is used for the treatment of the seed may vary depending upon the type of seed and the type of active ingredients, but the treatment will comprise contacting the seeds with an agriculturally effective amount of the encapsulated microbial composition. An “effective amount”, as used herein, generally, is an amount sufficient to effect beneficial or desired results. An effective amount can be applied in one or more administrations.

In addition to the coating layer, the seed may be treated with one or more of the following ingredients: other pesticides including fungicides and herbicides, herbicidal safeners, fertilizers, and/or biocontrol agents. These ingredients may be added as a separate layer or alternatively may be added in the coating layer.

The encapsulated microbial compositions and/or seed coating formulations may be applied to the seeds using a variety of techniques and machines, such as fluidized bed techniques, a roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are known in the art.

The encapsulated microbial compositions described herein may also be enveloped with a film overcoating to protect the coating (e.g., prior to application to seeds, etc.) Such overcoatings may be applied using fluidized bed and drum film coating techniques. For instance, in any embodiment, one or more hydrophobic additives may be additionally applied to the encapsulated microbial composition (e.g., during drying as part of the fluidized bed technique, etc.) In such embodiment, the hydrophobic additives may provide a coating around the composition, for example, during drying, etc.

In any embodiment, encapsulated microbial compositions described herein may be introduced onto a seed by use of solid matrix priming. For example, a quantity of an encapsulated microbial composition can be mixed with a solid matrix material and then the seed can be placed into contact with the solid matrix material for a period to allow the composition to be introduced to the seed. The seed can then optionally be separated from the solid matrix material and stored or used, or the mixture of solid matrix material plus seed can be stored or planted directly. Solid matrix materials which are useful herein may include polyacrylamide, starch, clay, silica, alumina, soil, sand, polyurea, polyacrylate, or any other material capable of absorbing or adsorbing the composition(s) herein for a time and releasing that composition into or onto the seed. In various examples, it may be useful for the composition(s) herein and the solid matrix material to be compatible with each other. For example, the solid matrix material may be chosen so that it can release the composition at a reasonable rate, for example over a period of minutes, hours, or days.

It is contemplated herein that any plant seed capable of germinating to form a plant may be treated as described above, for example, a vegetable seed, a fruit seed, a grain seed, and combinations thereof. Suitable seeds include those of cereals, coffee, cole crops, fiber crops, flowers, fruits, legume, oil crops, trees, tuber crops, vegetables, as well as other plants of the monocotyledonous, and dicotyledonous species. That said, example crop seeds that may be coated include, but are not limited to, bean, canola, carrot, corn, cotton, grasses, lettuce, peanut, pepper, potato, rapeseed, rice, rye, sorghum, soybean, sugarbeet, sunflower, tobacco, tomato, and wheat seeds.

### III. Methods for Preparing an Encapsulated Microbial Composition

Methods for preparing encapsulated microbial compositions as described herein are also provided. The methods may include: (a) combining a microbe as described herein and at least one hydrogel as described herein to form a precursor mixture; (b) solidifying the precursor mixture with a cross-linking agent to form an intermediate microbial composition; and (c) drying the intermediate microbial composition to form the encapsulated microbial composition. The methods described herein can surprisingly achieve more stable encapsulated microbial compositions having increased storage stability. For example, as described above, the encapsulated microbial compositions formed by the methods provided herein can exhibit a minimal loss of microbe colony forming unit per gram (CFU/g) as described herein. For example, the encapsulated microbial composition can have less than two logs or less than one log loss of colony forming unit per gram (CFU/g) after 4 weeks, 8 weeks or 12 weeks at 25° C. and 65% RH. Additionally, the encapsulated microbial compositions formed by the methods provided herein can have a lower water content as described herein, for example, a water content less than or equal to about 10% or less than or equal to about 5%. Further, the encapsulated microbial compositions formed by the methods provided herein may have increased tapped densities as described herein, for example, a tapped density of greater than or equal to about 0.5 g/mL to less than or equal to about 1.5 g/mL.

In any embodiment, the at least one hydrogel may include an alginate as described herein and optionally, may include a further hydrogel as described herein. The at least one hydrogel may be present in the precursor mixture in an amount, based on total weight of the precursor mixture, of greater than or equal to about 2.5 wt %, greater than or equal to about 5 wt %, greater than or equal to about 10 wt %, greater than or equal to about 20 wt %, less than or equal to about 60 wt %, less than or equal to about 50 wt %, less than or equal to about 40 wt %, or less than or equal to about 30 wt %, or from about 5 wt % to about 60 wt %, about 5 wt % to about 50 wt %, about 5 wt % to about 40 wt %, about 5 wt % to about 30 wt %, about 5 wt % and about 20 wt %, about 10 wt % to about 60 wt %, about 10 wt % to about 50 wt %, about 10 wt % to about 40 wt %, about 10 wt % to about 30 wt %, or about 10 wt % and about 20 wt %, etc. In any embodiment, the at least one hydrogel may be present in the precursor mixture in amount, based on total weight of the precursor mixture, from about 5 wt % to about 50 wt %.

Additionally or alternatively, the precursor mixture may further include a stabilizer as described herein, such as a nitrogen-containing stabilizer as described herein, a sugar-containing stabilizer as described herein, or a combination thereof. The stabilizer, e.g., the nitrogen-containing stabilizer and the sugar-containing stabilizer, singularly or in combination, may be present in the precursor mixture in an amount, based on total weight of the precursor mixture, of greater than or equal to about 2.5 wt %, greater than or equal to about 5 wt %, greater than or equal to about 10 wt %, greater than or equal to about 20 wt %, less than or equal to about 60 wt %, less than or equal to about 50 wt %, less than or equal to about 40 wt %, or less than or equal to about 30 wt %, or from about 5 wt % to about 60 wt %, about 5 wt % to about 50 wt %, about 5 wt % to about 40 wt %, about 5 wt % to about 30 wt %, about 5 wt % and about 20 wt %, about 10 wt % to about 60 wt %, about 10 wt % to about 50 wt %, about 10 wt % to about 40 wt %, about 10 wt % to about 30 wt %, or about 10 wt % and about 20 wt %, etc. In any embodiment, the nitrogen-containing stabilizer and the sugar-containing stabilizer, singularly or in combination, may be present in the precursor mixture in an amount, based on total weight of the precursor mixture, from about 5 wt % to about 50 wt %.

Additionally or alternatively, the precursor mixture may further include a filler as described herein. The filler may be present in the precursor mixture in an amount, based on total weight of the precursor mixture, of greater than or equal to about 0.1 wt %, greater than or equal to about 1 wt %, greater than or equal to about 2.5 wt %, greater than or equal to about 5 wt %, greater than or equal to about 10 wt %, greater than or equal to about 20 wt %, greater than or equal to about 30 wt %, greater than or equal to about 40 wt %, greater than or equal to about 50 wt %, less than or equal to about 95 wt %, less than or equal to about 90 wt %, less than or equal to about 80 wt %, less than or equal to about 70 wt %, or less than or equal to about 60 wt %, or from about 0.1 wt % to about 95 wt %, about 0.1 wt % to about 90 wt %, about 0.1 wt % to about 80 wt %, about 0.1 wt % to about 70 wt %, about 0.1 wt % to about 60 wt %, about 0.1 wt % to about 50 wt %, about 0.1 wt % to about 40 wt %, about 0.1 wt % to about 30 wt %, about 0.1 wt % to about 20 wt %, about 0.1 wt % to about 10 wt %, about 0.1 wt % to about 5 wt %, about 0.1 wt % to about 2.5 wt %, about 10 wt % to about 95 wt %, about 10 wt % to about 90 wt %, about 10 wt % to about 80 wt %, about 10 wt % to about 70 wt %, about 10 wt % to about 60 wt %, about 10 wt % to about 50 wt %, about 10 wt % to about 40 wt %, about 10 wt % to about 30 wt %, about 10 wt % to about 20 wt %, about 50 wt % to about 95 wt %, about 50 wt % to about 90 wt %, about 50 wt % to about 80 wt %, about 50 wt % to about 70 wt %, or about 50 wt % to about 60 wt %, etc. In any embodiment, a filler may be present in the precursor mixture in an amount, based on total weight of the precursor mixture, from about 0.1 wt % to about 90 wt %.

Additionally or alternatively, the precursor mixture may further optionally include one or more additional component, such as, but not limited to, surfactants, dispersants, emulsifiers, wetters, adjuvants, solubilizers, penetration enhancers, protective colloids, adhesion agents, thickeners, humectants, repellents, attractants, feeding stimulants, compatibilizers, anti-freezing agents, anti-foaming agents, colorants, tackifiers, hydrophobic additives, and/or binders.

The components of the precursor mixture, e.g., microbe, hydrogel, stabilizer, optional filler, and optional additional component may be combined in any suitable manner and order. For example, the microbe may be combined with the hydrogel and added to a protectant aqueous solution including, for example, a stabilizer, optional filler, and any other optional additional components described herein. It is contemplated herein, that the hydrogel may be present as an aqueous solution, which may be mixed prior to combination with the microbe. Alternatively, the hydrogel and microbe may be added separately to the protectant aqueous solution and combined therein. The protectant aqueous solution may be mixed prior to addition of the microbe and/or hydrogel.

### A. Solidifying the Precursor Mixture

The cross-linking agent may comprise a divalent cation as described herein, a divalent cation salt, or a combination thereof. For example, the divalent cation can be a barium (Ba²⁺) cation, a calcium (Ca²⁺) cation, a magnesium (Mg²⁺) cation, a strontium (Sr²⁺) cation, a cobalt (Co²⁺) cation, a nickel (Ni²⁺) cation, a zinc (Zn²⁺) cation, a manganese (Mn²⁺) cation, and combinations thereof. Examples of the divalent cation salt include, but are not limited to, a barium salt, a calcium salt, a magnesium salt, a strontium salt, a cobalt salt, a zinc salt, a manganese salt, or a combination thereof. Examples of salts include, but are not limited to, a chloride salt, a fluoride salt, a bromide salt, an iodide salt, a carbonate salt, a citrate salt, and combinations thereof. In any embodiment, the cross-linking agent may be calcium chloride (CaCl₂), calcium carbonate (CaCO₃), or a combination thereof. Additionally or alternatively, the cross-linking agent may be present in solution with a solvent, for example, water.

i. Bead Solidifying Methods

In any embodiment, the solidifying step may include contacting droplets of the precursor mixture with the cross-linking agent to form the intermediate microbial composition, which is in a form of cross-linked beads. Any suitable device may be used to generate droplets of the precursor mixture, for example, the precursor mixture may be pumped or flowed through tubing with a suitable cross-section to generate the droplets, which are then contacted with the cross-linking agent, for example, an aqueous solution comprising the cross-linking agent. Optionally, the cross-linked beads may undergo filtering and/or washing to remove any excess divalent cations.

The cross-linked beads may have an average particle diameter of greater than or equal to about 500 μm, greater than or equal to about 1 mm, greater than or equal to about 10 mm, greater than or equal to about 15 mm, less than or equal to about 20 mm, less than or equal to about 50 mm, less than or equal to about 40 mm, less than or equal to about 30 mm, or less than or equal to about 25 mm, or from about 500 μm to about 50 mm, about 500 μm to about 30 mm, about 500 μm to about 20 mm, about 1 mm to about 50 mm, about 1 mm to about 40 mm, about 1 mm to about 30 mm, about 1 mm to about 20 mm, about 1 mm to about 25 mm, or about 1 mm to about 15 mm, etc.

Thus, in various aspects, a method for preparing an encapsulated microbial composition as described herein is provided, where the method generally includes: (a) combining a microbe as described herein and at least one hydrogel as described herein, e.g., an alginate, to form a precursor mixture as described herein; (b) solidifying the precursor mixture with a cross-linking agent as described herein to form an intermediate microbial composition in a form of cross-linked beads, wherein the solidifying comprises contacting droplets of the precursor mixture with the cross-linking agent; and (c) drying the intermediate microbial composition to form the encapsulated microbial composition as described herein.

In alternative embodiments, the solidifying step may include flowing the precursor mixture through an aperture having a suitable diameter and contacting the precursor mixture as it exits the aperture with the cross-linking agent to form the intermediate microbial composition, which is in a form of cross-linked microbeads. The aperture may have a diameter of greater than or equal to about 50 μm, greater than or equal to about 100 μm, greater than or equal to about 150 μm, less than or equal to about 650 μm, less than or equal to about 500 μm, less than or equal to about 450 μm, or less than or equal to about 300 μm; or from about 50 μm to about 650 μm, about 50 μm to about 500 μm, about 50 μm to about 450 μm, about 50 μm to about 250 μm, about 50 μm to about 150 μm, about 100 μm to about 650 μm, about 100 μm to about 500 μm, about 100 μm to about 450, about 100 μm to about 250 μm, or about 100 μm to about 150 μm, etc. An example of a device in which the precursor mixture may be flowed through, may include any commercially available encapsulation device having an aperture (e.g., nozzle) with a diameter as described above. The nozzle may vibrate, and the bead sizes can be varied through nozzle size, vibration frequency and flow rate and hydrogel viscosity (temperature). An example of commercially available encapsulation device is Encapsulator B-390 (available from BÜCHI Labortechnik AG). As the precursor mixture exits the encapsulation device, it can be injected into the cross-linking agent, for example, an aqueous solution comprising the cross-linking agent. Optionally, the cross-linked microbeads may undergo filtering and/or washing to remove any excess divalent cations.

The cross-linked microbeads may have an average particle diameter of greater than or equal to about 50 μm, greater than or equal to about 100 μm, greater than or equal to about 250 μm, greater than or equal to about 500 μm, greater than or equal to about 750 μm, less than or equal to about 30 mm, less than or equal to about 20 mm, less than or equal to about 15 mm, less than or equal to about 10 mm, or less than or equal to about 1 mm, or from about 50 μm to about 30 mm, about 50 μm to about 20 mm, about 50 μm to about 1 mm, about 100 μm to about 30 mm, about 100 μm to about 20 mm, about 100 μm to about 10 mm, about 100 μm to about 1 mm, about 100 μm to about 750 μm, about 100 μm to about 500 μm, or about 100 μm to about 250 μm, etc.

Thus, in various aspects, a method for preparing an encapsulated microbial composition as described herein is provided, where the method generally includes: (a) combining a microbe as described herein and at least one hydrogel as described herein, e.g., an alginate, to form a precursor mixture as described herein; (b) solidifying the precursor mixture with a cross-linking agent as described herein to form an intermediate microbial composition in a form of cross-linked microbeads as described wherein, wherein the solidifying comprises flowing the precursor mixture through an aperture, e.g., having a diameter of about 100 μm to about 500 μm, and contacting the precursor mixture with the cross-linking agent; and (c) drying the intermediate microbial composition to form the encapsulated microbial composition as described herein.

ii. High Shear Mixing Solidifying Methods

Additionally or alternatively, the solidifying step may include high shear mixing of the precursor mixture as described herein with the cross-linking agent as described herein. For example, the precursor mixture may be combined with the cross-linking agent, for example, as an aqueous solution comprising the cross-linking agent, and the combination may undergo high shear mixing. The term “high shear mixing” refers to mixing or mixing processes which involves shear rates in excess of or more than 1000 s⁻¹. High shear mixing may be achieved with any suitable high shear mixing devices, such as, but not limited to, vortex mixers and homogenizers, etc. Any suitable commercially available vortex mixer or homogenizer may be used. An example commercially available homogenizer is a Kinematica POLYTRON® homogenizer (available from KINEMATICA AG).

In any embodiment, high shear mixing may be performed at a mixing tip speed of greater than or equal to about 2 m/s, greater than or equal to about 3.5 m/s, greater than or equal to about 5 m/s, greater than or equal to about 7.5 m/s, greater than or equal to about 10 m/s, less than or equal to about 30 m/s, less than or equal to about 25 m/s, less than or equal to about 20 m/s, or less than or equal to about 15 m/s, or from about 2 m/s to about 30 m/s, about 2 m/s to about 25 m/s, about 2 m/s to about 20 m/s, about 3.5 m/s to about 30 m/s, about 3.5 m/s to about 25 m/s, about 3.5 m/s to about 20 m/s, about 3.5 m/s to about 15 m/s, or about 3.5 m/s to about 10 m/s, etc.

Additionally or alternatively, high shear mixing may be performed at greater than or equal to about 1,000 rpm, greater than or equal to about 2,500 rpm, greater than or equal to about 5,000 rpm, greater than or equal to about 7,500 rpm, greater than or equal to about 10,000 rpm, less than or equal to about 15,000 rpm, or less than or equal to about 12,500 rpm, or from about 1,000 rpm to about 15,000 rpm, about 1,000 rpm to about 12,500 rpm, about 10,000 rpm to about 10,000 rpm, about 1,000 rpm to about 7,500 rpm, about 1,000 rpm to about 5,000 rpm, or about 1,000 rpm to about 2,500 rpm, etc.

Additionally or alternatively, high shear mixing may be performed for greater than or equal to about 2.5 seconds, greater than or equal to about 5 seconds, greater than or equal to about 30 seconds, greater than or equal to about 1 minute, greater than or equal to about 5 minutes, less than or equal to about 25 minutes, less than or equal to about 20 minutes, less than or equal to about 15 minutes, or less than or equal to about 10 minutes, or from about 2.5 seconds to about 25 minutes, about 2.5 seconds to about 20 minutes, about 2.5 seconds to about 15 minutes, about 2.5 seconds to about 10 minutes, about 2.5 seconds to about 5 minutes, about 2.5 seconds to about 1 minute, about 2.5 seconds to about 30 seconds, about 5 seconds to about 25 minutes, about 5 seconds to about 20 minutes, about 5 seconds to about 15 minutes, about 5 seconds to about 10 minutes, about 5 seconds to about 5 minutes, about 5 seconds to about 1 minute, or about 5 seconds to about 30 seconds, etc. In any embodiment, high shear mixing may be performed with a tip speed of greater than or equal to about 3.5 m/s, e.g., about 3.5 m/s to about 25 m/s, for greater than or equal to about 5 seconds, e.g., about 5 seconds to about 20 minutes.

Additionally or alternatively, high shear mixing may be performed at a temperature, for example, ambient temperature and/or temperature of the mixture of precursor mixture and cross-linking agent, of greater than or equal to about 1° C., greater than or equal to about 4° C., greater than or equal to about 10° C., greater than or equal to about 15° C., less than or equal to about 35° C., less than or equal to about 30° C., less than or equal to about 25° C., or less than or equal to about 20° C., or from about 1° C. to about 35° C., about 1° C. to about 30° C., about 1° C. to about 25° C., about 1° C. to about 20° C., about 1° C. to about 15° C., about 1° C. to about 10° C., about 1° C. to about 4° C., about 4° C. to about 35° C., about 4° C. to about 30° C., about 4° C. to about 25° C., about 4° C. to about 20° C., about 4° C. to about 15° C., or about 4° C. to about 10° C., etc.

Thus, in various aspects, a method for preparing an encapsulated microbial composition as described herein is provided, where the method generally includes: (a) combining a microbe as described herein and at least one hydrogel as described herein, e.g., an alginate, to form a precursor mixture as described herein; (b) solidifying the precursor mixture with a cross-linking agent as described herein to form an intermediate microbial composition, wherein the solidifying comprises high shear mixing of the precursor mixture with the cross-linking agent as described herein; and (c) drying the intermediate microbial composition to form the encapsulated microbial composition as described herein.

iii. Carbonate Salt Solidifying Methods

Additionally or alternatively, the solidifying step may include combining the precursor mixture with the cross-linking agent to form the intermediate microbial composition, wherein the cross-linking agent comprises the divalent cation salt and the divalent cation salt may be a divalent cation carbonate. For example, the divalent cation carbonate may be barium carbonate, calcium carbonate, magnesium carbonate, strontium carbonate, cobalt carbonate, nickel carbonate, zinc carbonate, manganese carbonate, or combinations thereof. In any embodiment, the divalent cation carbonate may be calcium carbonate.

Additionally or alternatively, the solidifying may further include adding an acidic buffer to the precursor mixture and/or cross-linking agent. Any suitable acidic buffer may be added which has a pH of about 7 or lower including, but not limited to, an acetate buffer (e.g., solution of acetic acid and a salt of acetic acid (e.g., sodium acetate), a glucono-delta lactone buffer, a weak acid (e.g., citric acid, formic acid, oxalic acid, hydrofluoric acid, nitrous acid, sulfurous acid, phosphoric acid, etc.) and a combination thereof.

The acidic buffer may be added in a variety of manners and orders. For example, the acidic buffer may be added: (i) to the precursor mixture and/or the cross-linking agent before the cross-linking agent is combined with the precursor mixture; (ii) to the precursor mixture substantially simultaneously along with the cross-linking agent; (iii) to a mixture comprising the precursor mixture and the cross-linking agent; or any combination of (i), (ii), and (iii). The mixture comprising the cross-linking agent, the precursor mixture, and optional acidic buffer may have a pH and/or be maintained at a pH of greater than or equal to about 2, greater than or equal to about 4, greater than or equal to about 5, less than or equal to about 7, less than or equal to about 6.5, or less than or equal to about 6, or from about 2 to about 7, about 2 to about 6.5, about 2 to about 6, about 2 to about 5, about 2 to about 4, about 4 to about 7, about 4 to about 6.5, about 4 to about 6, or about 4 to about 5, etc.

In any embodiment, the precursor mixture, the cross-linking agent, and optional acidic buffer may be combined for greater than or equal to about 5 minutes, greater than or equal to about 30 minutes, greater than or equal to about 2 hours, greater than or equal to about 6 hours, greater than or equal to about 12 hours, greater than or equal to about 18 hours, less than or equal to about 48 hours, less than or equal to about 42 hours, less than or equal to about 36 hours, less than or equal to about 30 hours, or less than or equal to about 24 hours, or from about 5 minutes to about 48 hours, about 5 minutes to about 42 hours, about 5 minutes to about 36 hours, about 5 minutes to about 30 hours, about 5 minutes to about 24 hours, about 5 minutes to about 18 hours, about 5 minutes to about 12 hours, about 5 minutes to about 6 hours, about 5 minutes to about 2 hours, or about 5 minutes to about 30 hours, etc. During this aforementioned time period the mixture comprising the precursor mixture, the cross-linking agent, and optional acidic buffer may be mixed with any suitable mixer for any of the above described time periods and/or the mixture may be allowed to sit without any further mixing for the any of the above described time periods. For the example, the mixture comprising the precursor mixture, the cross-linking agent, and optional acidic buffer may be mixed for about 5 minutes to about 6 hours and then allowed to stand for an additional about 18 hours to about 30 hours.

Additionally or alternatively, the precursor mixture, the cross-linking agent, and optional acidic buffer may be combined at a temperature, for example, ambient temperature and/or temperature of the mixture of precursor mixture, the cross-linking agent, and optional acidic buffer, of greater than or equal to about 1° C., greater than or equal to about 4° C., greater than or equal to about 10° C., greater than or equal to about 15° C., less than or equal to about 40° C., less than or equal to about 30° C., less than or equal to about 25° C., or less than or equal to about 20° C., or from about 1° C. to about 40° C., about 1° C. to about 30° C., about 1° C. to about 25° C., about 1° C. to about 20° C., about 1° C. to about 15° C., about 1° C. to about 10° C., about 1° C. to about 4° C., about 4° C. to about 35° C., about 4° C. to about 40° C., about 4° C. to about 25° C., about 4° C. to about 20° C., about 4° C. to about 15° C., or about 4° C. to about 10° C., etc. In any embodiment, the precursor mixture, the cross-linking agent, and optional acidic buffer may be combined for greater than or equal to about 5 minutes, e.g., about 5 minutes to about 48 hours performed at a temperature greater than or equal to about 4° C., e.g., about 4° C. to about 40° C.

Thus, in various aspects, a method for preparing an encapsulated microbial composition as described herein is provided, where the method generally includes: (a) combining a microbe as described herein and at least one hydrogel as described herein, e.g., an alginate, to form a precursor mixture as described herein; (b) solidifying the precursor mixture with a cross-linking agent comprising a divalent cation salt, e.g., a divalent cation carbonate, as described herein to form an intermediate microbial composition, wherein the solidifying comprises combining the precursor mixture with the cross-linking agent; and (c) drying the intermediate microbial composition to form the encapsulated microbial composition as described herein.

When performing any of the above described solidifying steps (e.g., bead solidifying, high shear mixing, carbonate salt solidifying, etc.), the divalent cation may be present in an amount of greater than or equal to about 0.001%, greater than or equal to about 0.1%, greater than or equal to about 1%, greater than or equal to about 2.5%, greater than or equal to about 5%, less than or equal to about 30%, less than or equal to about 25%, less than or equal to about 20%, less than or equal to about 15%, less than or equal to about 10%, or less than or equal to about 7.5%, or from about 0.001% to about 25%, about 0.001% to about 20%, about 0.001% to about 15%, about 0.001% to about 10%, about 0.001% to about 7.5%, about 0.001% to about 5%, about 0.001% to about 2.5%, about 0.001% to about 1%, about 0.1% to about 25%, about 0.1% to about 20%, about 0.1% to about 15%, about 0.1% to about 10%, about 0.1% to about 7.5%, about 0.1% to about 5%, about 0.1% to about 2.5%, or about 0.1% to about 2.5%, etc. of a total dry weight of the encapsulated microbial composition. For example, when performing any of the bead solidifying steps, the divalent cation may present in an amount of about 0.1% to about 10% of a total dry weight of the encapsulated microbial composition. Additionally, when performing any of the high shear mixing or carbonate salt solidifying steps, the divalent cation may present in an amount of about 0.001% to about 25% of a total dry weight of the encapsulated microbial composition.

It is also contemplated herein that the intermediate microbial composition formed, for example, following the high shear mixing solidifying step or the carbonate salt solidifying step, may be applied to any suitable substrate and the intermediate microbial composition may be in a form of a film disposed on the substrate. The film may have a thickness of greater than or equal to about 1 mm, greater than or equal to 2.5 mm, greater than or equal to 5 mm, greater than or equal to about 7.5 mm, less than or equal to about 5 cm, less than or equal to about 2.5 cm, or less than or equal to about 1 cm, or from about 1 mm to about 5 cm, about 1 mm to about 2.5 cm, about 1 mm to about 1 cm, about 1 mm to about 7.5 mm, about 1 mm to about 5 mm, or about 1 mm to about 2.5 mm, etc.

### B. Drying the Intermediate Microbial Composition

As described above, it has been surprisingly discovered that encapsulated microbial compositions with increased stability can be achieved via methods described herein which include a slower drying step, for example, by utilizing a slower evaporation rate at a lower temperature.

Slower drying may be accomplished, for example, by maintaining a slower evaporation rate of the intermediate microbial composition. Such drying may be achieved (or performed, or accomplished, etc.), for example, in (or by use of) air (e.g., air drying, open air drying, forced or directed air drying), vacuum drying, fluid bed drying, etc.), a dryer, an oven, a humidity-controlled chamber, or (or by use of) any combination thereof. For example, drying can be performed with an evaporation rate of less than or equal to about 30,000 g/hr/m², less than or equal to about 25,000 g/hr/m², less than or equal to about 20,000 g/hr/m², less than or equal to about 15,000 g/hr/m², less than or equal to about 10,000 g/hr/m², less than or equal to about 5,000 g/hr/m², less than or equal to about 1,000 g/hr/m², less than or equal to about 500 g/hr/m², less than or equal to about 100 g/hr/m², less than or equal to about 50 g/hr/m², less than or equal to about 10 g/hr/m², greater than or equal to about 1 g/hr/m², greater than or equal to about 10 g/hr/m², greater than or equal to about 25 g/hr/m², greater than or equal to about 50 g/hr/m², greater than or equal to about 100 g/hr/m², greater than or equal to about 250 g/hr/m², greater than or equal to about 500 g/hr/m², or greater than or equal to about 1,000 g/hr/m², or from about 1 g/hr/m² to about 25,000 g/hr/m², from about 10 g/hr/m² to about 25,000 g/hr/m², from about 25 g/hr/m² to about 25,000 g/hr/m², from about 50 g/hr/m² to about 25,000 g/hr/m², from about 1 g/hr/m² to about 20,000 g/hr/m², from about 50 g/hr/m² to about 20,000 g/hr/m², from about 1 g/hr/m² to about 15,000 g/hr/m², from about 50 g/hr/m² to about 15,000 g/hr/m², from about 1 g/hr/m² to about 10,000 g/hr/m², from about 50 g/hr/m² to about 10,000 g/hr/m², from about 1 g/hr/m² to about 5,000 g/hr/m², from about 50 g/hr/m² to about 5,000 g/hr/m², from about 1 g/hr/m² to about 1,000 g/hr/m², from about 50 g/hr/m² to about 1,000 g/hr/m², from about 1 g/hr/m² to about 500 g/hr/m², from about 50 g/hr/m² to about 500 g/hr/m², from about 1 g/hr/m² to about 250 g/hr/m², from about 50 g/hr/m² to about 250 g/hr/m², or from about 1 g/hr/m² to about 100 g/hr/m², from about 50 g/hr/m² to about 100 g/hr/m², from about 1 g/hr/m² to about 50 g/hr/m², from about 1 g/hr/m² to about 30 g/hr/m² etc. In any embodiment, the evaporation rate may be from about 1 g/hr/m² to about 150 g/hr/m², from about 50 g/hr/m² to about 150 g/hr/m², etc.

In any embodiment, drying may be performed with a drying temperature of greater than or equal to about 10° C., greater than or equal to about 15° C., greater than or equal to about 20° C., less than or equal to about 60° C., less than or equal to about 50° C., less than or equal to about 40° C., less than or equal to about 30° C., or less than or equal to about 25° C., or from about 10° C. to about 50° C., about 10° C. to about 40° C., about 10° C. to about 30° C., about 10° C. to about 25° C., about 10° C. to about 20° C., about 10° C. to about 15° C., about 15° C. to about 50° C., about 15° C. to about 40° C., about 15° C. to about 30° C., about 15° C. to about 25° C., or about 15° C. to about 20° C., etc. In any embodiment, the drying temperature may be about 15° C. to about 50° C.

Additionally or alternatively, drying may be performed for a drying time of greater than or equal to about 10 minutes, greater than or equal to about 15 minutes, greater than or equal to about 30 minutes, greater than or equal to about 1 hour, greater than or equal to about 12 hours, greater than or equal to about 24 hours, greater than or equal to about 48 hours, greater than or equal to about 72 hours, less than or equal to about 288 hours, less than or equal to about 240 hours, less than or equal to about 200 hours, less than or equal to about 170 hours, less than or equal to about 144 hours, or less than or equal to about 96 hours, or from about 10 minutes to about 288 hours, about 15 minutes to about 288 hours, about 15 minutes to about 240 hours, about 15 minutes to about 200 hours, about 15 minutes to about 170 hours, about 15 minutes to about 144 hours, about 15 minutes to about 96 hours, about 15 minutes to about 72 hours, about 15 minutes to about 48 hours, about 15 minutes to about 24 hours, about 15 minutes to about 12 hours, about 15 minutes to about 1 hour, or about 15 minutes to about 30 minutes, etc. In any embodiment, the drying time may be about 15 minutes to about 200 hours.

As described, it is contemplated herein that drying of the intermediate microbial composition may be performed in (or by use of) air (e.g., air drying, open air drying, forced or directed air drying), vacuum drying, fluid bed drying, etc.), a dryer, an oven, a humidity-controlled chamber, or in (or by use of) any combination thereof. For example, the intermediate microbial composition may be allowed to sit at room temperature (e.g., about 15° C. to about 25° C.) in air for a drying time as described above (e.g., about 24 hours to about 72 hours), optionally followed by further drying in a humidity-controlled chamber at temperature of about 20° C. to about 30° C. for about 15 minutes to about 72 hours, and optionally followed by further drying in a dryer (e.g., fluid bed dryer) at temperature(s) of about 40° C. to about 60° C. for about 15 minutes to about 72 hours.

In any embodiment, the intermediate microbial composition may be allowed to sit at room temperature (e.g., about 15° C. to about 25° C.) in air for a drying time as described above (e.g., about 24 hours to about 72 hours). In doing so, a tapped density of the resultant composition formed via air drying of the intermediate microbial composition as described above may be relatively greater than that of a composition formed via spray drying, etc. For instance, in any embodiment, the tapped density of the composition formed via air drying of the intermediate microbial composition as described above may be greater than the tapped density of a composition formed via spray drying by at least about 5%, at least about 10%, at least about 15%, at least about 20%, at least about 25%, at least about 30%, at least about 35%, at least about 40%, at least about 45%, at least about 50%, at least about 55%, at least about 60%, at least about 75%, at least about 100%, at least about 150%, at least about 200%, at least about 250%, or about 300%; or from about 5% to about 300%, etc.

In any embodiment, drying of the intermediate microbial composition may be performed, achieved, etc. by way of air drying. In doing so, for example, Crosslinked Alginate Microbe Mixtures (CAMMs) may be generated by either the shear mix method or bead/microbead method herein (see, e.g., Example 3, etc.) and spread on a sheet or surface (e.g., a 9″×13″ baking sheet, another other sheet or surface, etc.), and then placed in a biohood with air recirculation to air-dry the mixtures for 24-72 hours at room temperature (e.g., about 18° C. to about 25° C. (about 64° F. to about 78° F.), etc.). After the 24-72 hours at room temperature, the CAMMS (on the surface) may be moved to a humidity-controlled chamber set at generally (or relatively) low relative humidity (RH) (e.g., between about 10% and about 20%, etc.) or to a drying chamber with a dry air purge (e.g., less than about 5% RH, etc.) to facilitate complete drying (e.g., less than about 5% moisture content in the dried alginate, etc.)

In any embodiment, drying of the intermediate microbial composition may be performed, achieved, etc. by way of fluid bed drying. In doing so, for example, Crosslinked Alginate Microbe Mixtures (CAMMs) may be generated by the bead/microbead method herein (see, e.g., Example 3, etc.) and loaded into a fluid bed dryer, for example, a Sherwood Scientific 50100201 Programmable Fluid Bed Dryer from Sherwood Scientific Ltd. or a Freund Vector VFC-Lab Micro Flo-Coater® from Freund-Vector Corporation. The fluid bed dryer may then be operated at a temperature of between about 20° C. and about 60° C. for about 1 hour to about 8 hours until the moisture content of the microbeads is less than about 5%. Alternatively, the microbeads could be removed from the fluid bed dryer while not fully dry, but still as a free-flowing powder, and then dried in a vacuum oven at between about 20° C. and about 40° C. until their moisture content is less than about 5%.

In any embodiment, drying of the intermediate microbial composition may be performed, achieved, etc. by way of vacuum drying. In doing so, for example, Crosslinked Alginate Microbe Mixtures (CAMMs) may be generated by the bead/microbead method herein (see, e.g., Example 3, etc.) and loaded into a vacuum dryer, for example, a vacuum paddle dryer, agitated vacuum dryer, or conical screw vacuum dryer. The vacuum drying may then be operated at a temperature of between about 20° C. and about 50° C. for about 1 hour to about 8 hours until the moisture content of the microbeads is less than about 5%.

### C. Optional Further Processing

The encapsulated microbial composition may undergo optional further processing for further applications, for example, use as a seed treatment and/or prior to application to a seed. Further processing may include, for example, milling the encapsulated microbial composition to form encapsulated microbial particles and/or to further reduce the size of the encapsulated microbial particles. Any suitable milling process known in the art may be used to form the encapsulated microbial particles, for example, ball milling, freeze milling, or a combination thereof.

In any embodiment, the encapsulated microbial particles may have a diameter of greater than or equal to about 1 μm, greater than or equal to about 15 μm, greater than or equal to about 25 μm, greater than or equal to about 50 μm, greater than or equal to about 75 μm, greater than or equal to about 100 μm, less than or equal to about 500 μm, less than or equal to about 350 μm, or less than or equal to about 200 μm, or from about 1 μm to about 500 μm, from about 1 μm to about 350 μm, from about 1 μm to about 200 μm, from about 1 μm to about 100 μm, from about 1 μm to about 75 μm, from about 1 μm to about 50 μm, from about 1 μm to about 25 μm, or from about 1 μm to about 15 μm, etc.

### EXAMPLES

The following non-limiting examples are provided to further illustrate the present disclosure. Non-limiting examples of microbial formulations and methods of making and testing such formulations are provided, which may be useful for encapsulation and improved stability of microorganisms, particularly fungal strains and non-spore forming bacterial strains.

### Example 1. Preparation of the Microbial Strains

### Microbe Strains and Growth Conditions

Bradyrhizobium japonicum (OPTIMIZE® XC) was stored at 4° C. before use.

Pseudomonas fluorescens, Phytobacter diazotrophicus, Herbasprillum frisingense, and Pseudacidovorax intermedius fermentations were prepared fresh for each experiment from −80° C. frozen stocks. The cells were grown in a rich complex medium (3 g/L beef extract, 5 g/L peptone water, 6 g/L mannitol, 30 g/L glucose, 18.9 g/L trehalose, 15 mM HEPES buffer, pH about 7.2) in a shake flask for 18-48 hours at 28° C. Typically, the optical density of the culture, measured at 600 nm, rose from 0.05 to within a range of 1.5 to 2.5 during the overnight fermentation.

### CFU (Colony Forming Unit) Measurement

Cultures were diluted serially in PBS buffer to obtain desired amount of Colony Forming Units (CFU) per milliliter. The bacteria were quantified by plating appropriate dilutions on agar plates and incubated overnight at 30° C. The colonies grown on plates were counted. Final CFU/mL was calculated by multiplying the colony count with the dilution factor. To determine loading rate and stability profile, CFU measurements of strains may be taken before encapsulation, after encapsulation, and after different time periods of storage.

### Example 2. Preparation of Alginate Microbe Mixtures (AMMs)

Mixtures comprising protectants, a microbe of interest and alginates were prepared from the following solutions. The prepared microbial culture (20 mL, undiluted) and alginate solution were added to the protectant solution to generate Alginate Microbe Mixtures (AMMs) that were used to prepare Crosslinked Alginate Microbe Mixtures (CAMMs).

### Protectant Solution

A protectant solution was prepared as follows: 4 grams soluble starch, 10 grams skim milk powder, 10 grams sucrose, 5 grams maltodextrin, 200 uL of 1000× minor nutrient component consisting of 0.0012 g/mL magnesium sulfate, 0.018 g/mL mannitol, 0.117 g/L betaine, 0.342 g/mL trehalose, 0.167 g/mL dipicolinic acid, and two drops of Antifoam 204 was added to 180 grams MilliQ water (i.e., purified and deionized water), and homogenized in a high shear mixer.

### Alginate Solution

An alginate solution was prepared as follows: 8.0 grams of sodium alginate was added to 192 grams of MilliQ water to form a 4% w/w sodium alginate mixture. The mixture was heated to 55° C. and mixed in a shaker until homogeneous and cooled to room temperature.

The following reagents were used without additional purification: “Std” Sodium alginate from brown algae (Sigma Aldrich W201502); Sodium alginate from brown algae, low viscosity (Sigma Aldrich A1112); Sodium alginate from brown algae, medium viscosity (Sigma Aldrich A2033); Sodium alginate, high viscosity (Alfa Aesar J61887); water soluble chitosan (Carbosynth YC58325); Pectin (from apple, Sigma-Aldrich 93854); and Gelatin (from bovine skin type B, Sigma Aldrich G9391).

### Example 3. Preparation of Crosslinked Alginate Microbe Mixtures (CAMMs)

Different types of Crosslinked Alginate Microbe Mixtures (CAMMs) were prepared via the following methods.

### CAMM Beads

Crosslinked alginate microbe mixture (CAMM) beads were prepared as follows: 300 mL of the AMM preparation in Example 2 above was pumped at 57 rpm (Watson-Marlow pump, Model: 120U/DM3) through a 1.6 mm inner diameter tubing (Masterflex HV-06508-14) to generate droplets of the AMM preparation. The droplets were directed into a liter of 1.0 w/w % CaCl₂ solution. Solid crosslinked alginate beads formed upon contact with the calcium ions in the solution. The beads were filtered and rinsed with water to remove excess calcium ions.

As an example, a typical preparation of Pseudomonas fluorescens CAMM beads after drying contained 1×10⁸ to 1×10⁹ CFU/gram. Beads made by this method were typically greater than 1 centimeter in diameter.

### CAMM Microbeads

Crosslinked alginate microbe mixture (CAMM) microbeads were prepared as follows: 300 mL of the AMM preparation in Example 2 above was injected into a liter of 1.0 w/w % CaCl₂) solution using a commercial encapsulation unit (Encapsulator B-390, BUCHI, Switzerland) to prepare the hydrogel microbeads. The encapsulation device was operated under fixed conditions: frequency=1500 Hz; electrode potential=1000 V; and operating pressure=500-1000 mbar. Nozzle sizes of 150, 200, and 450 μm generated final wet microbead sizes after encapsulation of 560 μm, 750 μm, and greater than 1 mm, respectively.

As an example, a typical preparation of Pseudomonas fluorescens CAMM microbeads after drying contained 1×10⁹ to 3×10⁹ CFU/gram. Microbeads made by this method for use according to these Examples were typically greater than 1 millimeter in diameter.

### Shear Mix Method

Shear mixed crosslinked alginate microbe formulations were prepared as follows: 2.5 mL of 1% w/w calcium chloride solution was added into 100 mL of the Alginate Microbe Mixture prepared as in Example 2 above. The combination was mixed with a Kinematica POLYTRON® homogenizer (available from KINEMATICA AG, Luzernerstrasse 147A CH-6014 Littau, Switzerland) at 11,000 rpm for 20-30 seconds. The consistency of the crosslinked alginate became thick and paste-like.

### Calcium Carbonate

Instead of calcium chloride, a calcium carbonate solution was used for crosslinking. Crosslinked alginate microbe formulations were prepared as follows: 0.09 grams of calcium carbonate was added to 100 grams of alginate microbe mixture (AMM). The mixture was vigorously mixed in a horizontal shaker for 4 hours and left to stand for an additional 24 hours at room temperature. The calcium carbonate was neutralized with the addition of either 10 mL of 100 mM acetate buffer (AC) or 100 mM glucono-delta-lactone (GDL) and vigorously mixed in a horizontal shaker for 4 hours and left to stand for an additional 24 hours at room temperature.

### Example 4. Drying Crosslinked Alginate Microbe Mixtures

Crosslinked alginate microbe mixtures (CAMMs) were spread on a 9″×13″ baking sheet and placed in a biohood with air recirculation to air-dry the mixtures for at least 2 days at room temperature until the moisture content reached 5-10%. For example, the CAMM beads or microbeads were air-dried for 3 days at room temperature.

Alternatively, the crosslinked alginate microbe mixtures (CAMMs) were spread on a 9″×13″ baking sheet and placed in a biohood with air recirculation to air-dry the mixtures for 24 hours at room temperature and placed in a humidity-controlled chamber at 23° C. and 20% relative humidity (RH) to reduce moisture content to 5-7%.

To further reduce moisture content, crosslinked alginate particles were dried in a Sherwood Scientific 50100201 Programmable Fluid Bed Dryer fluid bed dryer at 45-55° C., until the moisture content was reduced to about 3%.

### Example 5. Milling Crosslinked Alginate Microbe Mixtures

Crosslinked alginate microbe mixtures (CAMMs) were milled to generate powder particles suitable for long term storage and seed treatment. The crosslinked alginate microbe mixtures were freeze milled with liquid nitrogen (Spex Sample Prep Model 6970D) with milling parameters as follows: Cycles: 3 min, Pre-cool: 0 min, run time: 7 min, Cool between Run: 1 min, Rate 13 cycles per second (cps).

Alternatively, the materials were size-reduced using a ball mill, by loading 10 grams of the dried materials in a 125 mL wide-mouth jar with 3×20 mm metal balls as grinder. The container was vigorously shaken using a horizontal shaker for 1 hour at room temperature.

A typical milled preparation yielded a particle size distribution of D10=8-15 μm, D50=75-100 μm, and D90=350-500 μm.

### Example 6. Spray-Drying Methods

Crosslinked Alginate Microbe Mixtures (CAMMs) were prepared via the following spray drying methods. A BÜCHI® Mini Spray Dryer B-290 (BÜCHI Labortechnik AG, Flawil, Switzerland) was employed to complete encapsulation and drying.

### Two-Fluid Nozzle Spray Drying and Polymer Encapsulation

CAMM formulations were spray-dried using a BÜCHI® B-290 lab spray dryer equipped with a standard two-fluid nozzle. The spray drying procedure for producing cross-linked alginate microparticles was as follows: air flow was set at 40 mm, and air pressure at 90 psi. Aspiration was set at 100%, and the dehumidifier was set to “on.” The pump speed was calibrated to ˜10 m/min using water and set to 32%. The inlet temperature ranged from 110-170° C., which resulted in an outlet temperature range of 50-87° C.

### Three-Fluid Nozzle Spray Drying and Polymer Encapsulation

CAMM formulations were spray-dried using a BÜCHI® B-290 lab spray dryer equipped with a three-fluid nozzle. The spray drying procedure for producing cross-linked alginate microparticles was as follows: air flow was set at maximum and air pressure of 90 psi. Aspiration was set at 100%, and the dehumidifier was set to “on.” A WATSON MARLOW® 120U multichannel pump with 1.42 mm×0.8 mm tubing (part number 983.0142.000) inner feed pump was calibrated to −5 mL/min using water and set to 57%. Inner fluid contained equal volumes of microbial fermentate and aqueous 4% sodium alginate/2% soluble starch solution unless otherwise noted, outer (BÜCHI®) feed pump=17% (calibrated to ˜5 mL/min using water). Outer fluid: dilute aqueous calcium chloride (typically 0.125-0.25 wt %) unless otherwise noted. Cold water from the tap was pumped through the spray nozzle assembly. The inlet temperature ranged from 110-120° C., which resulted in an outlet temperature range of 50-87° C.

### Example 7. Seed Treatment

Microbial alginate formulations were applied to seed using the following procedures. Formulations were applied to soybean seeds that were either untreated or treated with a crop-protection chemistry.

To apply wet or dry crosslinked alginate formations to seeds, 250 grams of soybean seeds and 1.0 grams of a seed treatment sugar solution (if using) were placed into a gallon size bag, sealed, and shook vigorously. The bag was reopened, and 1.5 grams of the crosslinked alginate formulation was added, the bag resealed, and shook vigorously to ensure an even coating. The sugar solution makes the surfaces of the seeds “sticky” so that the alginate formulation powder coats and adheres to the surfaces of the seeds.

The treated seeds were transferred to a breathable lined paper bag (3.375 inches×2.5 inches×10.25 inches; Midco TTX591) for long term storage in 25° C./65% RH and/or 10° C./50% RH.

### Example 8. Recovery of Pseudomonas fluorescens Encapsulated with a Dry Crosslinked Alginate Using Bead Method

Pseudomonas fluorescens was encapsulated via the CAMM bead method, dried, and milled as described in Examples 3, 4 and 5 above. The calcium chloride concentration used to gel the beads was varied from 0.5%-5% to determine its impact on CFU recovery.

As shown in Table 1, CFU recovery of Pseudomonas fluorescens from the CAMM beads shortly after encapsulation was highest with the lower calcium chloride concentrations tested (0.5% CaCl₂ had the highest CFU recovery). CFU recovery was determined by plating in an agar plate.

TABLE 1
Initial CFU Recovery of Pseudomonas fluorescens
Encapsulated in Dried CAMM Beads made with
Different Concentrations of Calcium Chloride

| Calcium Chloride Concentration | CFU/gram |
|---|---|
| 0.5% CaCl₂ | 1.4 × 10¹⁰ |
| 1.0% CaCl₂ | 1.07 × 10⁹ |
| 2.5% CaCl₂ | 1.32 × 10⁸ |
| 5.0% CaCl₂ | <1 × 10⁷ |

### Example 9. Recovery of Pseudomonas fluorescens Encapsulated with Dry Crosslinked Alginate Made Via Shear-Mix Method

Pseudomonas fluorescens was encapsulated via the CAMM shear-mix method as described in Example 3 above with or without the addition of different combinations of hydrogels (chitosan, pectin, gelatin) and/or inert carriers (biochar) to the alginate microbial mixtures before crosslinking. When added, the ratio of alginate to the additional hydrogel was 1:1, and the total hydrogel concentration was 2%. If no additional hydrogel was added, then the concentration of alginate was 2%, but if an additional hydrogel was added, the concentrations of alginate and hydrogel were each 1% (for a total of 2% combined). When added, the ratio of alginate to additional biochar was 2:5 by dry weight. The crosslinked formulations were dried and milled as described in Examples 4 and 5 above.

All combinations with or without a hydrogel or inert carrier provided greater than 1×10⁸ CFU/gram recovery, and many combinations had greater than 1×10⁹ CFU/gram recovery of the Pseudomonas fluorescens strain, as shown in Table 2, indicating the flexibility of the hydrogel type for the stabilization processes described herein.

TABLE 2
Initial CFU Recovery of Pseudomonas fluorescens Encapsulated in
Crosslinked Alginate Made via Shear-Mix Method

| | | Milling | |
|---|---|---|---|
| | Hydrogel Type | Method | CFU/gram |
| 1 | Alginate Only (batch 1) | Freeze Mill | 1.24 × 10⁹ |
| 2 | Alginate Only (batch 1) | Freeze Mill | 1.13 × 10⁹ |
| 3 | Alginate + Chitosan | Freeze Mill | 4.84 × 10⁸ |
| 4 | Alginate + Chitosan | Freeze Mill | 5.04 × 10⁸ |
| 5 | Alginate + Pectin | Freeze Mill | 1.20 × 10⁹ |
| | (pH unadjusted ~4.5) | | |
| 6 | Alginate + Pectin | Freeze Mill | 1.60 × 10⁹ |
| | (pH unadjusted ~4.5) | | |
| 7 | Alginate + Pectin | Freeze Mill | 1.90 × 10⁹ |
| | (pH adjusted 6.5) 2.5N NaOH | | |
| 8 | Alginate + Pectin | Freeze Mill | 2.53 × 10⁹ |
| | (pH adjusted 6.5) 2.5N NaOH | | |
| 9 | Alginate + Gelatin | Freeze Mill | 2.49 × 10⁹ |
| 10 | Alginate + Gelatin | Freeze Mill | 2.99 × 10⁹ |
| 11 | Alginate (+Biochar) | Freeze Mill | 1.69 × 10⁹ |
| 12 | Alginate (+Biochar) | Freeze Mill | 9.15 × 10⁸ |
| 13 | Alginate Only (batch 2) | Freeze Mill | 2.29 × 10⁹ |
| 14 | Alginate Only (batch 2) | Freeze Mill | 5.08 × 10⁹ |
| 15 | Alginate Only (batch 3) | Ball Mill | 1.00 × 10⁹ |
| 16 | Alginate Only (batch 3) | Ball Mill | 4.63 × 10⁹ |

### Example 10. Recovery of Pseudomonas fluorescens Encapsulated with Dry Crosslinked Alginate Made Via Calcium Carbonate Method

Pseudomonas fluorescens was encapsulated via the calcium carbonate method as described in Example 3 above with different alginate materials and with or without the addition of hydrogels (chitosan, pectin, gelatin) to the alginate microbial mixtures before crosslinking in the combinations provided in Example 9 and Table 2 above. The ratio of alginate to additional hydrogel was 1:1, and the total hydrogel concentration was 2% as above. The crosslinked formulations were dried and milled as described in Examples 4 and 5 above.

CAMMs made with different amounts of acetate buffer (AC) or glucono-delta-lactone (GDL) achieved greater than 1×10⁸ CFU/gram recovery, and many preparations had greater than 1×10⁹ CFU/gram recovery, as shown in Table 3, indicating the flexibility of the amount of acidifier for the stabilization processes described herein using calcium carbonate as the crosslinking agent. CAMMs made with different types of hydrogels achieved greater than 1×10⁹ CFU/gram recovery, as shown in Table 4, indicating the flexibility of the hydrogel type for the stabilization processes with the different alginates described herein.

TABLE 3
Initial CFU Recovery of Pseudomonas fluorescens
Encapsulated in Crosslinked Alginate Prepared with Different
Amounts of Acidifier via Calcium Carbonate Method

| Sample# | Acidifier/Vol (mL) | CFU/gram |
|---|---|---|
| 1 | AC/0 | 1.29 × 10⁹ |
| 2 | AC/1.50 | 7.04 × 10⁸ |
| 3 | AC/2.25 | 5.99 × 10⁸ |
| 4 | AC/3.00 | 8.57 × 10⁸ |
| 5 | AC/3.75 | 1.34 × 10⁹ |
| 6 | AC/6.00 | 2.70 × 10⁸ |
| 7 | GDL/0 | 1.37 × 10⁹ |
| 8 | GDL/1.50 | 1.50 × 10⁹ |
| 9 | GDL/2.25 | 2.46 × 10⁹ |
| 10 | GDL/3.00 | 1.14 × 10⁹ |
| 11 | GDL/3.75 | 1.37 × 10⁹ |
| 12 | GDL/6.00 | 4.35 × 10⁹ |

AC: Acetate buffer 100 mM
GDL: Glucono-delta-lactone 100 mM
Total mixture: 30 mL in 50 mL tube

TABLE 4
Initial CFU Recovery of Pseudomonas fluorescens Encapsulated in
Crosslinked Alginate Prepared with Additional
Hydrogels via Calcium Carbonate Method

| | Hydrogel Type | CFU/gram |
|---|---|---|
| 1 | Std 2.5 mL equiv | 2.78 × 10⁹ |
| 2 | Std 10 mL equiv | 5.41 × 10⁹ |
| 3 | Low viscosity 2.5 mL equiv | 4.30 × 10⁹ |
| 4 | Low viscosity 10 mL equiv | 4.25 × 10⁹ |
| 5 | Medium viscosity 2.5 mL equiv | 6.68 × 10⁹ |
| 6 | Medium viscosity 10 mL equiv | 7.87 × 10⁹ |
| 7 | High viscosity 2.5 mL equiv | 3.37 × 10⁹ |
| 8 | High viscosity 10 mL equiv | 7.96 × 10⁹ |
| 9 | Std Alginate + Gelatin 1:1 2.5 mL equiv | 4.22 × 10⁹ |
| 10 | Std Alginate + Gelatin 1:1 10 mL equiv | 3.38 × 10⁹ |
| 11 | Std Alginate + Chitosan 1:1 2.5 mL equiv | 1.15 × 10⁹ |
| 12 | Std Alginate + Chitosan 1:1 10 mL equiv | 1.16 × 10⁹ |
| 13 | Std Alginate + Pectin 1:1 2.5 mL equiv | 1.35 × 10⁹ |
| 14 | Std Alginate + Pectin 1:1 10 mL equiv | 8.20 × 10⁹ |

### Example 11. Recovery of Pseudomonas fluorescens Encapsulated with Dry Crosslinked Alginate Made Via Three-Fluid Nozzle Spray Drying

Shear-crosslinked alginate containing Pseudomonas fluorescens was generated and spray-dried using a three-fluid nozzle spray dryer as described in Example 3 above with different amounts of calcium chloride. The initial CFU measurement (starting titer) of the spray-dried CAMM powders are provided in Table 5.

TABLE 5
In-Situ Crosslinked Spray-Dried Formulations
Containing P. fluorescens

| | Outer Fluid in | Starting Titer |
|---|---|---|
| Inner Fluid in Spray Dryer | Spray Dryer | (CFU/gram) |
| 2% alginate/1% soluble starch | 0.125 wt. % CaCl₂ | 1.57 × 10⁹ |
| 2% alginate/1% soluble starch | 0.125 wt. % CaCl₂ | 4.28 × 10⁸ |
| 2% alginate/1% soluble starch | 0.0625 wt. % CaCl₂ | 3.81 × 10⁹ |
| 2% alginate/1% soluble starch | 0.25 wt. % CaCl₂ | 4.32 × 10⁹ |
| 2% alginate only | 0.125 wt. % CaCl₂ | 2.67 × 10⁹ |

### Example 12. Viability of Pseudomonas fluorescens On-Seed with Different Crosslinked Alginate Preparations

### Alginate Crosslinking Prior to Spray Drying

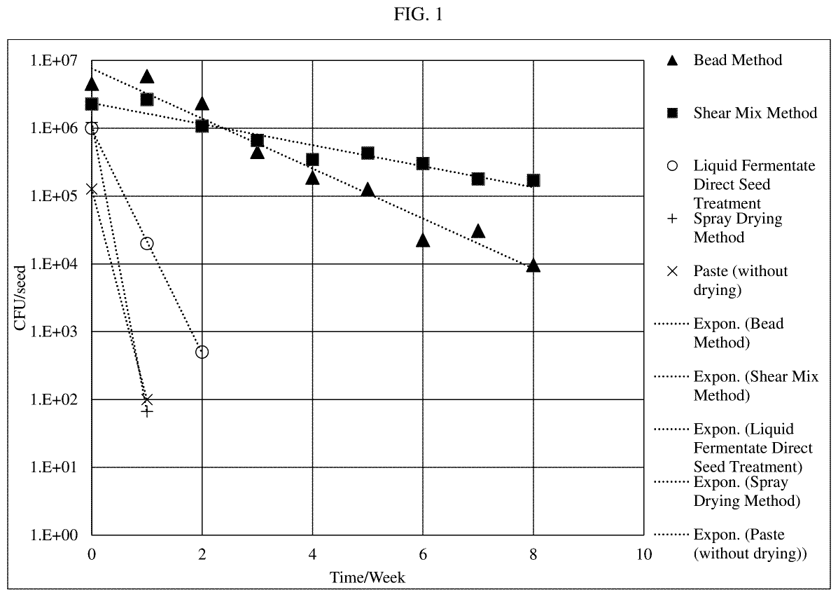

Crosslinked alginate containing Pseudomonas fluorescens was generated using the Shear Mix Method as described in Example 3 above, spray-dried using a two-fluid nozzle spray dryer as described in Example 6 above and applied to soybean seed as provided in Example 7 above. As shown in FIG. 1, Pseudomonas fluorescens encapsulated in the shear-crosslinked alginate mixture and applied to seeds maintained viability above 1×10⁵ CFU/seed for more than 8 weeks.

Direct Seed Treatment with Crosslinked Alginate Paste

Pseudomonas fluorescens was encapsulated in alginate via the shear mix method as described in Example 3 above, and applied to soybean seed as described herein, but without spray-drying the crosslinked alginate paste before applying to seed. In this experiment, the initial microbial titer was 1.7×10⁹ CFU/g for the crosslinked alginate paste. The impact of chemistry (AI), bisulfite treatment (to remove biocide in chemistry slurry), and osmoprotectant solutions on microbial stability was determined. The theoretical maximal amount of CFU/seed upon seed treatment, assuming no CFU loss, would be 1×10⁶ CFU/seed. The actual initial CFU/seed measured for all samples in this experiment were in the range of 10⁴-10⁵ CFU/seed, and after 1 week on seed, the CFU/seed had experienced a 1-3 log decrease (see Table 6).

The on-seed stability of Pseudomonas fluorescens after the direct seed treatment encapsulated in the alginate paste and applied to seed was low. Pseudomonas fluorescens was applied to seed as a cross-linked alginate paste that was not subjected to spray drying had a viability loss to less than 1×10² CFU/seed within 1 week (i.e., a drop off of at least 2-3 logs in CFU/seed in only a week on seed) (see FIG. 1).

TABLE 6
On-Seed Pseudomonas fluorescens Stability at 25° C./65% RH from Direct
Seed Treatment with Crosslinked Alginate Paste

| | Chemistry | Bisulfite Treatment | Added Osmo- | Initial | Week 1 |
|---|---|---|---|---|---|
| | Treatment | on Chemistry Slurry | Protectant | (CFU/seed) | (CFU/seed) |
| 11 | No | N.A. | Yes | 4.03 × 10⁵ | <10³ |
| 22 | No | N.A. | Yes | 3.27 × 10⁵ | <10³ |
| 33 | Yes, premixed with | No | Yes | 8.10 × 10⁴ | <10³ |
| 44 | Microbial-Alginate | No | Yes | 1.28 × 10⁵ | <10² |
| 45 | Paste | Yes | Yes | 1.53 × 10⁴ | <10² |

Impact of Encapsulation Methods and Drying Rate on Stability for Encapsulated Pseudomonas fluorescens at Different Temperatures and Humidities

Pseudomonas fluorescens was encapsulated in crosslinked alginate via the Shear Mix or Bead Methods and milled and placed on seed as described above. As illustrated in FIG. 1, the on-seed CFU/seed decay rate was at 0.15 log/week for seeds stored at 25° C. and 65% RH, as opposed to a near 2-log drop per week for the spray-dried liquid fermentate applied to seeds. Without spray drying, seeds treated with wet shear-mixed alginate formulations showed viability loss of the microbial strain to less than 1×10² CFU/seed within 1 week. These results indicate slower drying methods for crosslinked alginate mixtures provide more stable microbial formulations for on-seed applications.

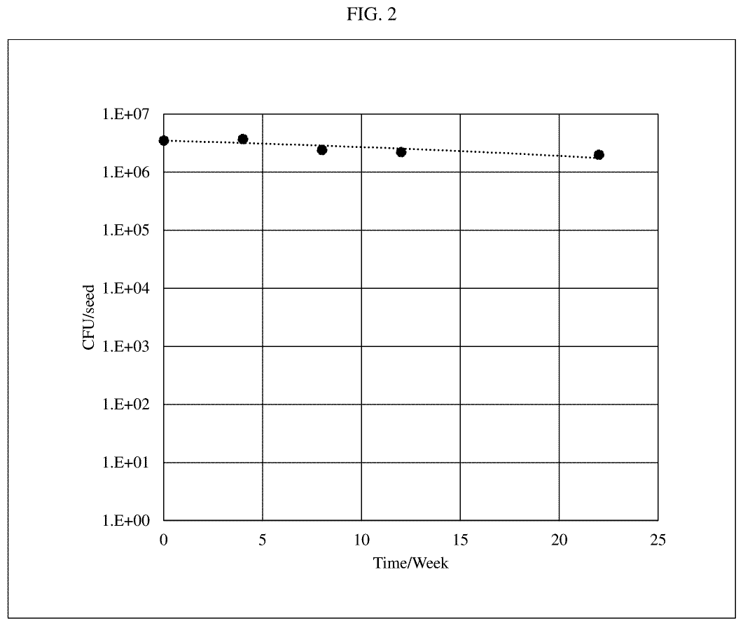

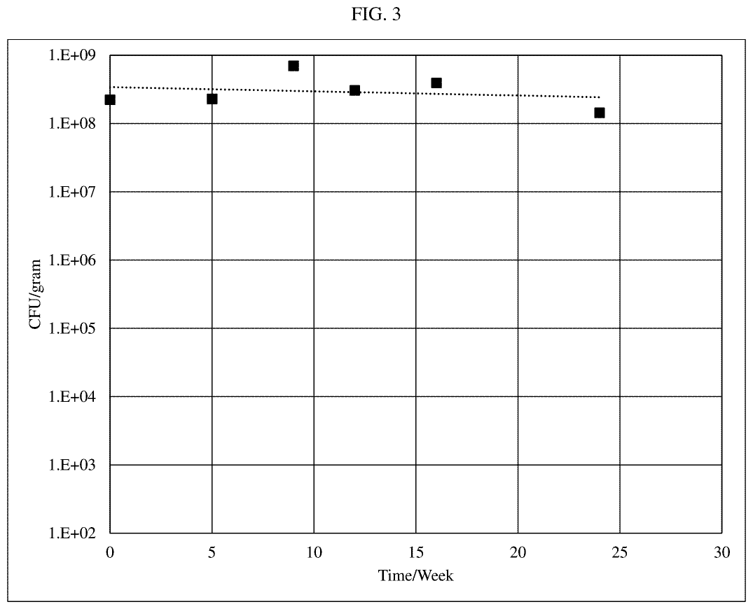

As further illustrated in FIG. 2, the numbers of CFUs per seed remained virtually unchanged over 23 weeks of testing period at 10° C. and 50% RH. In a further study, 10 grams of alginate encapsulated Pseudomonas fluorescens was stored in a 20 mL glass scintillation vial, a 2 gram desiccant package was added, the vial capped and stored at 25° C. chamber. Samples were taken periodically to track its long-term viability as shown in FIG. 3.

### Impact of Calcium Concentration on On-Seed Stability

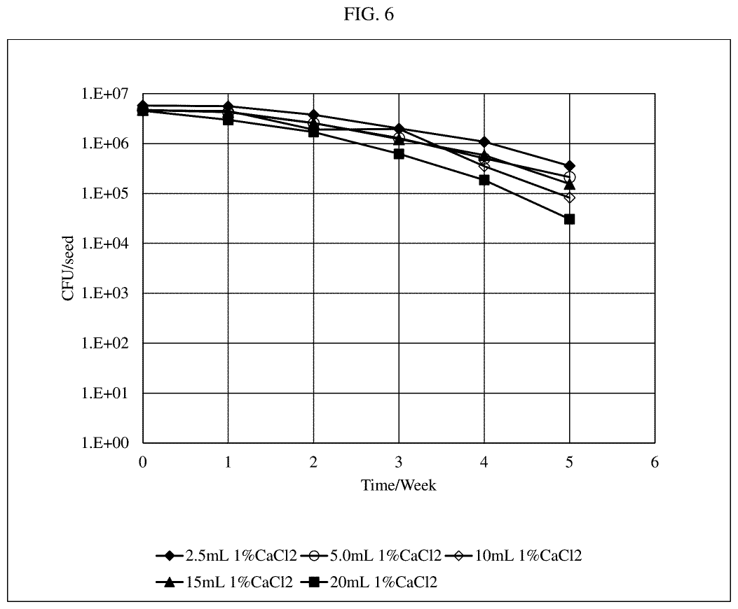

Pseudomonas fluorescens was encapsulated in alginate via the shear mix method, milled, and placed on seed as described herein. The amount of calcium chloride used to crosslink the alginate was varied. Pseudomonas fluorescens encapsulated in alginate using shear-mixed method yielded good stability within the first four weeks. For sample crosslinked at 2.5 mL 1% w/w calcium loading (relative to 100 mL alginate-microbe mixture), the decay rate was on average at 0.15 log/week as shown in FIG. 6.

On-Seed Stability with Additional Hydrogel or Biochar

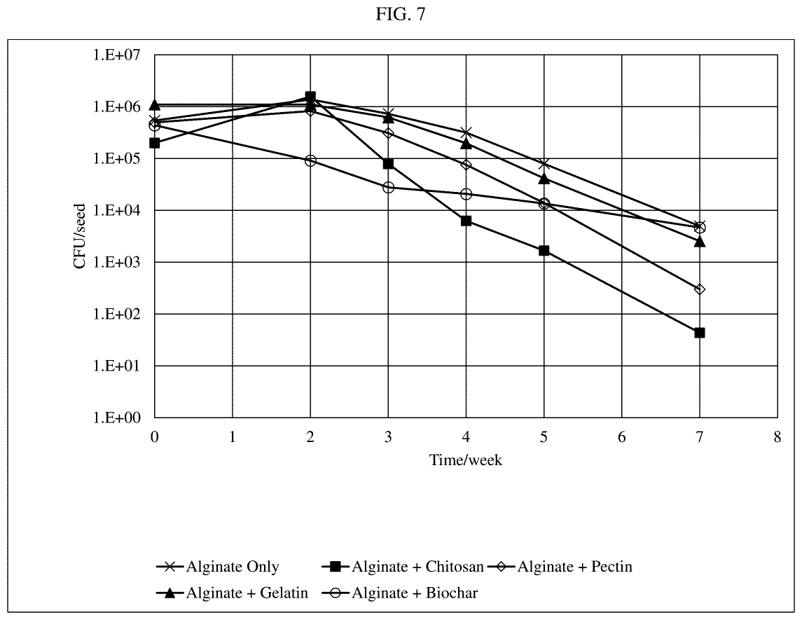

Pseudomonas fluorescens was encapsulated via the CAMM shear-mix method with the addition of hydrogels (chitosan, pectin, gelatin) and inert carriers (biochar) to the alginate microbial mixtures before crosslinking. The ratio of alginate to additional hydrogel was 1:1, and the total hydrogel concentration was 2%. The ratio of alginate to additional biochar was 2:5 by dry weight. The crosslinked formulations were dried and milled as described above, placed on seed, stored in a breathable paper bag, and exposed to warm temperature and humidity at 25° C./65% RH. Encapsulation with alginate as the only hydrogel yielded the greatest stability. Addition of biochar as a solid excipient further improved the stability with less than 1 log reduction from week 3-7 indicating the biochar acts as a stabilizing agent as shown in FIG. 7.

On-Seed Stability of Spray Dried Pseudomonas fluorescens Formulations

Pseudomonas fluorescens was encapsulated via the three-fluid nozzle spray drying CAMM shear-mix method, placed on seed, stored in a breathable paper bag, and exposed to warm temperature and humidity at 25° C./65% RH, as shown in Table 7 below. Their on-seed stability results are shown in FIG. 1. Drying and calcium chloride loading did not impact the stability trends. The inclusion of soluble starch also had no significant impact.

TABLE 7
In-Situ Crosslinked Spray-Dried Formulations Containing
Pseudomonas fluorescens Used for On-Seed Stability Testing

| Inner Fluid in | Outer Fluid in | Starting Titer | Initial |
|---|---|---|---|
| Spray Dryer | Spray Dryer | (CFU/gram) | CFU/Seed |
| 2% alginate/ | 0.125 wt. % CaCl₂ | 1.57 × 10⁹ | 1.03 × 10⁶ |
| 1% soluble starch | | | |
| 2% alginate/ | 0.125 wt. % CaCl₂* | 4.28 × 10⁸ | 3.70 × 10⁵ |
| 1% soluble starch | | | |
| 2% alginate/ | 0.0625 wt. % CaCl₂ | 3.81 × 10⁹ | 2.28 × 10⁶ |
| 1% soluble starch | | | |
| 2% alginate/ | 0.25 wt. % CaCl₂ | 4.32 × 10⁹ | 3.52 × 10⁵ |
| 1% soluble starch | | | |
| 2% alginate only | 0.125 wt. % CaCl₂ | 2.67 × 10⁹ | 1.38 × 10⁶ |

*indicates sample was dried in the vacuum oven at room temperature overnight prior to seed treatment.

### Example 13. Viability of Bradyrhizobium japonicum On-Seed with Different Crosslinked Alginate Preparations

Impact of Encapsulation Methods and Drying Rate on Stability for Encapsulated Bradyrhizobium japonicum at 25° C./65% RH and 10° C./50% RH

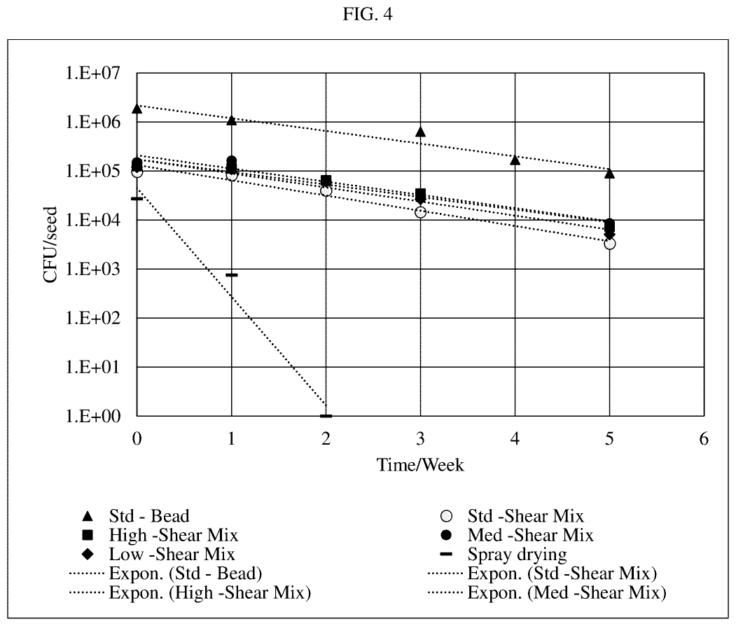

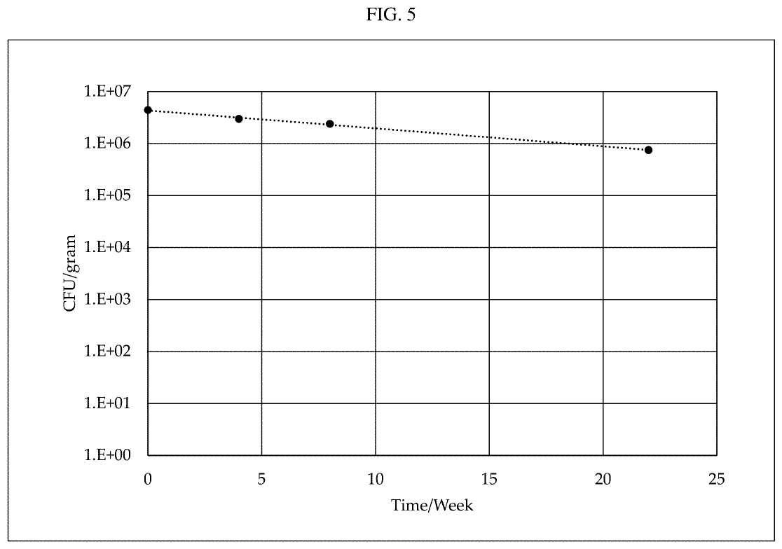

Bradyrhizobium japonicum was encapsulated in alginate via the shear mix and bead methods, milled, and placed on seed as described herein. In comparison, Bradyrhizobium japonicum was also spray-dried and treated on-seed to compare the impact of drying rate on stability. As illustrated in FIG. 4, at 25° C./65% RH, the on-seed CFU decay rate for both bead and shear method was comparable at 0.26-0.31 log/week. This is in contrast of about 1.5 log drop per week for spray-dried Bradyrhizobium. FIG. 5 shows, at 10° C./50% RH, the on-seed CFU decay is substantially reduced to 0.7 log over 23 weeks.

On-Seed Stability of Spray Dried Bradyrhizobium japonicum Formulations

Bradyrhizobium japonicum was encapsulated via the two-fluid nozzle spray drying CAMM shear-mix method, placed on seed, stored in a breathable paper bag, and exposed to warm temperature and humidity at 25° C./65% RH. The formulations were compared to commercial peat-based formulations as shown in Table below. The CFU/seed values for these formulations were evaluated for several weeks and used to determine log₁₀ decay rates.

TABLE 8
Initial CFU/seed values and on-seed decay rates (per week)
calculated from the storage stability testing at 25° C./65%
RH for various Bradyrhizobium japonicum formulations

| | Log₁₀ decay | Initial |
|---|---|---|
| Formulation | rate on-seed | CFU/seed |
| Spray-dried alginate | −1.518 | 2.72 × 10⁴ |
| Spray-dried alginate/modified starch | −1.301 | 1.33 × 10³ |
| Spray-dried polyacrylic acid (PAA) | −1.393 | 1.53 × 10⁴ |
| Spray-dried PAA/modified starch | −1.850 | 8.35 × 10³ |
| Spray-dried poly | −1.850 | 1.72 × 10⁴ |
| (styrene-alt-maleic acid) [PS-alt-MA] | | |
| Spray-dried PS-alt-MA/modified starch | −1.301 | 4.00 × 10² |

### Example 14. Release Study of Encapsulated Microbes

Alginate-encapsulated Pseudomonas, formulated with the bead method at 0.5% CaCl₂, was used as the model encapsulate material to assess the release of calcium-crosslinked alginate-encapsulated microbes. A study was conducted to determine how readily this preparation was able to deliver viable cells to the environment under simulated planting conditions, as a function of time and soil moisture content.

Agricultural field soil collected from Greenville, MS was oven-dried overnight at 65° C. and sterilized by autoclaving (121° C. at 15 psi for 30 minutes). 5-gram aliquots of the sterilized soil were distributed into sterile 50 mL centrifuge tubes, and samples with moisture contents ranging from about 0% to about 30% were created through the addition of sterile water. Soy seeds were sown into these samples and evaluated for their ability to germinate after 96 hours at 22° C. under these conditions as shown in Table 9.

TABLE 9
Composition of Soil Samples and Resulting
Effect on Germination of Soy

| Moisture | | | Soy |
|---|---|---|---|
| Content | Soil (g) | Water (mL) | Germination |
| ~0% | 5 | 0.000 | No |
| 10% | 5 | 0.556 | Yes |
| 20% | 5 | 1.250 | Yes |
| 30% | 5 | 2.143 | No |

The alginate-encapsulated microbial preparation used for this study was determined to contain about 1×10⁹ CFU/g. That material was combined and mixed with the dry, sterilized field soil to produce a new soil preparation, containing about 2.4×10³ CFU/g. 5 gram aliquots of the soil+alginate-encapsulated P. fluorescens mixture were distributed into sterile 50 mL centrifuge tubes, and samples with moisture contents ranging from about 0% to about 30% were created in triplicate through the addition of sterile water, as described above.

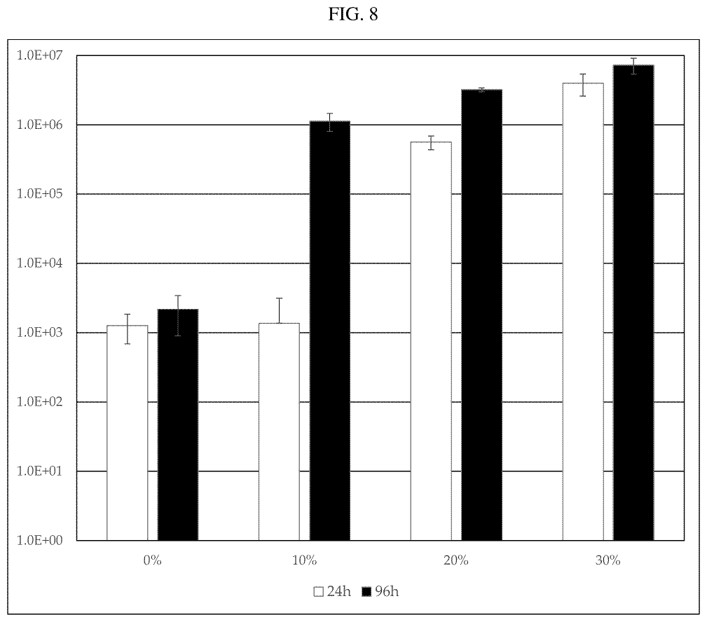

Each sample was incubated at 22° C. after the addition of water. Aliquots were taken at 24 hours and 96 hours and assayed for CFU/g using serial dilution plating and colony enumeration on R2A growth media. These counts are summarized in Table 10 and illustrated in FIG. 8.

TABLE 10
CFU/g after 24 hours and 96 hours Incubation with Varied Soil Moisture Content

| | CFU/g After 24 h | | | | CFU/g After 96 h | | | |
|---|---|---|---|---|---|---|---|---|
| Moisture | Rep 1 | Rep 2 | Rep 3 | Average | Rep 1 | Rep 2 | Rep 3 | Average |
| 0% | 1.6 × 10³ | 6.0 × 10² | 1.6 × 10³ | 1.3 × 10³ | 3.3 × 10³ | 8.0 × 10² | 2.4 × 10³ | 2.2 × 10³ |
| 10% | 3.4 × 10³ | 2.0 × 10² | 5.0 × 10² | 1.4 × 10³ | 8.9 × 10⁵ | 1.5 × 10⁶ | 1.0 × 10⁶ | 1.1 × 10⁶ |
| 20% | 6.8 × 10⁵ | 5.8 × 10⁵ | 4.3 × 10⁵ | 5.6 × 10⁵ | 3.2 × 10⁶ | 3.0 × 10⁶ | 3.4 × 10⁶ | 3.2 × 10⁶ |
| 30% | 2.4 × 10⁶ | 5.0 × 10⁶ | 4.6 × 10⁶ | 4.0 × 10⁶ | 6.1 × 10⁶ | 6.2 × 10⁶ | 9.4 × 10⁶ | 7.2 × 10⁶ |

The results of this study indicate that the microbial population is readily released from this alginate-encapsulation, and actively grows to high titers after 96 hours incubation in soils with moisture contents between 10-30%. Release and subsequent growth of microbes is slower in drier soils, as indicated by the initial lack of growth after 24 hours incubation in soil with a 10% moisture content. The encapsulate material appears to be stable for this timeframe in dry soil, as the concentration of viable cells remained at the initial baseline titer of about 2.4×10³ CFU/g.

### Example 15. Tapped Density Measurements and Moisture Absorption Properties of Different Crosslinked Alginate Preparations Containing Pseudomonas fluorescens

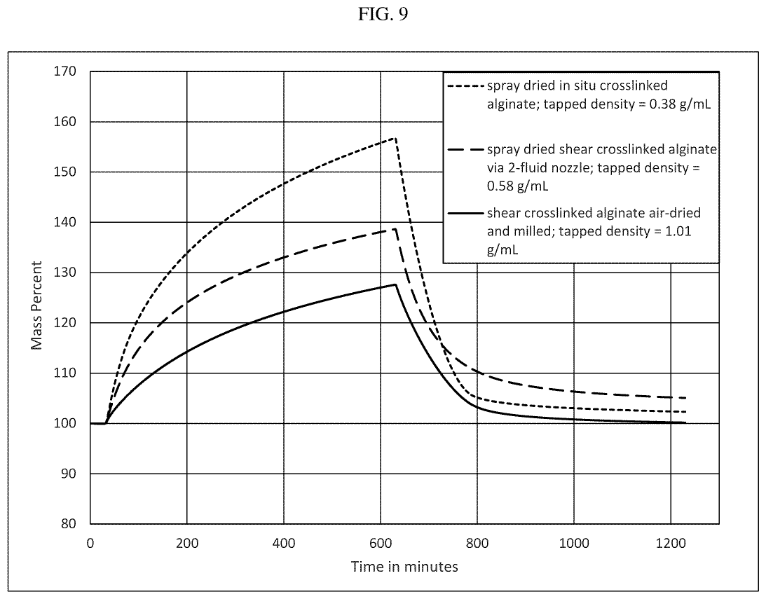

Various dry alginate formulations containing Pseudomonas fluorescens were generated via the CAMM shear mix method in Example 3 and the spray drying methods in Example 6. The tapped density of these powder formulations was determined using a manual method using 2 mL cryogenic vials as the measuring vessel and is shown in Table 11 below. The moisture absorption of these formulations was compared in a dynamic vapor sorption (DVS) system (e.g., a DVS system from Surface Measurement Systems, etc.) after drying them in a vacuum oven at 40° C. overnight using the following program: 0.5 hours at 0% RH (mass adjusted to 100% afterwards), 10 hours at 90% RH, and 10 hours at 0% RH. The DVS data (FIG. 9) shows that the denser formulations absorb less moisture under the same % RH. The higher rate of moisture absorption contributes to the lower on-seed stability of spray-dried formulations shown in FIG. 1.

TABLE 11

| | Tapped |
|---|---|
| Sample Description | Density (g/mL) |
| CAMM by shear cross-linking, after | 1.01 |
| drying in a film and milling into a powder | |
| spray dried shear crosslinked alginate | 0.571 |
| spray dried shear crosslinked alginate (2× calcium) | 0.575 |
| spray dried in-situ crosslinked | 0.384 |
| alginate/starch formulation (3-fluid nozzle) | |

### Example 16. Viability of Herbaspirillum frisingense On-Seed with Crosslinked Alginate Preparation

Impact of Formulation Additives on Stability for Encapsulated Herbaspirillum frisingense at 25° C./65% RH Compared to Liquid Fermentation

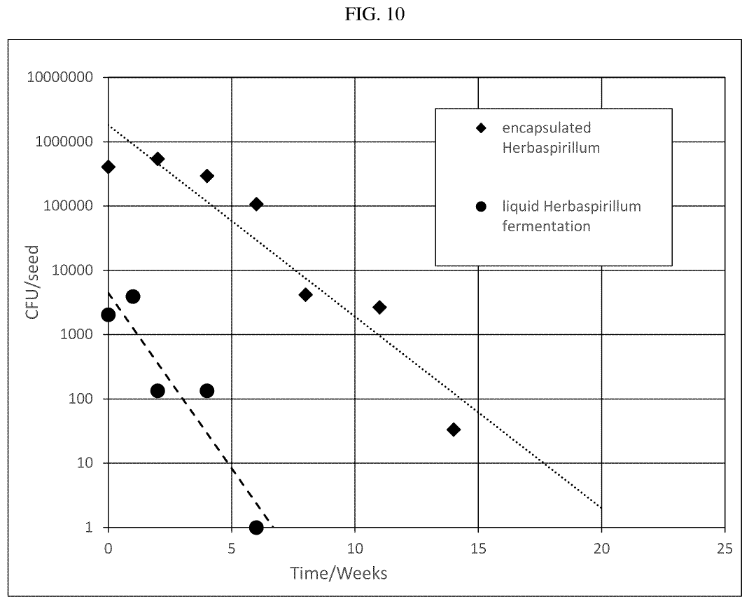

Herbaspirillum frisingense was encapsulated in alginate via the shear mix method, dried in a sheet, milled via a freeze mill, and placed on seed as described herein. A Herbaspirillum frisingense fermentation was applied directly on-seed to compare the stability of the encapsulated formulation to the on-seed stability of the liquid. The fermentation was applied in a similar manner to the seed treatment described in Example 7, using 1 mL of fermentation broth applied directly onto the seeds without any binder solution. The treated seeds were transferred into poly-lined paper bags (3.375 inches×2.5 inches×10.25 inches; Midco BA TT CW-6L) for long term storage in 25° C./65% RH. As illustrated in FIG. 10, at 25° C./65% RH, the on-seed stability of all the encapsulated formulation is significantly better than the liquid fermentation applied directly on-seed.

### Example 17. Viability of Encapsulated Pseudacidovorax intermedius On-Seed Compared to Liquid Fermentation

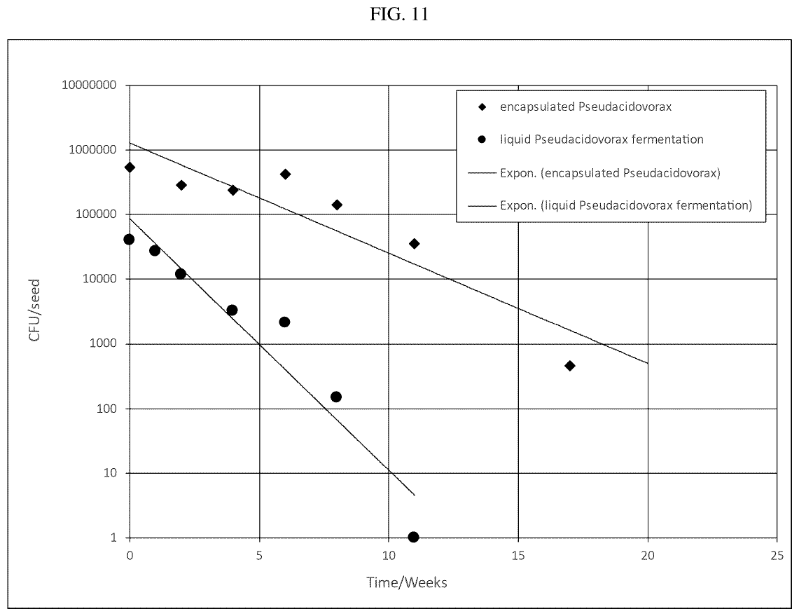

Pseudacidovorax intermedius was encapsulated in alginate via the shear mix method, dried in a sheet, milled via a freeze mill, and placed on seed as described herein. Pseudacidovorax intermedius fermentation was also applied directly on-seed to compare the stability of the encapsulated formulation to the on-seed stability of the liquid. The fermentation was applied in a similar manner to the seed treatment described in Example 7, with using 1 mL of fermentation broth applied directly onto the seeds without any binder solution added. These treated seeds were transferred into poly-lined paper bags (3.375 inches×2.5 inches×10.25 inches; Midco BA TT CW-6L) for long term storage in 25° C./65% RH. As illustrated in FIG. 11, at 25° C./65% RH, the on-seed stability of all the encapsulated formulation is significantly better than the liquid fermentation applied directly on-seed.

### Example 18. Viability of Phytobacter diazotrophicus On-Seed with Different Crosslinked Alginate Preparations

Impact of Formulation Additives on Stability for Encapsulated Phytobacter diazotrophicus at 25° C./65% RH Compared to Liquid Fermentation

Phytobacter diazotrophicus was encapsulated in alginate via the shear mix method, dried in a sheet, milled via a freeze mill, and placed on seed as described herein. Several commercial hydrophobic additives, shown in Table 12, were included into the AMM prior to cross-linking at 1.5 wt/vol % in the mixture to see the impact of these additives on moisture uptake of the powder formulation prior to seed treatment as well as the on-seed stability.

TABLE 12

| | |
|---|---|
| Additive #1 | AQUACOAT ® ECD30 (from Dupont; |
| | a 30 wt % aqueous dispersion of ethylcellulose) |
| Additive #2 | SSB ® AQUAGOLD (from Stroever Shellack Bremen; |
| | a 25 wt % aqueous solution of ammonium shellac salt) |
| Additive #3 | AQUACER ® 497 |
| | (from BYK; a 50 wt % paraffin-based wax emulsion) |

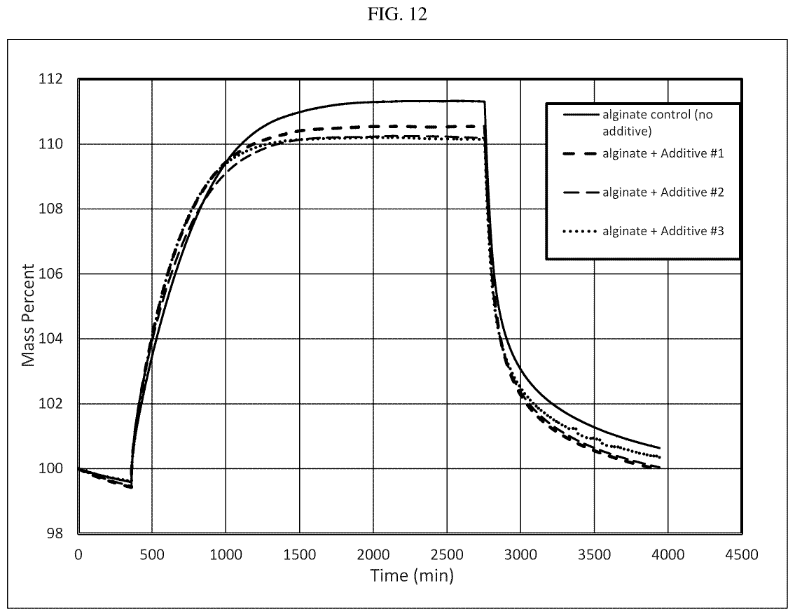

After drying and milling, the powder formulations were further dried in a vacuum oven at 40° C. for 24 hours. Moisture uptake evaluated via a dynamic vapor sorption (DVS) instrument (from Surface Measurement Systems DVS Advantage) at 65% RH. The DVS program was as follows: 6 hours at 0% RH (mass adjusted to 100% afterwards), 40 hours at 65% RH, and 20 hours at 0% RH. FIG. 12 shows that the incorporation of hydrophobic additives reduces the mass change upon exposure to 65% RH, with Additive #2 and #3 having the biggest reduction in moisture uptake.

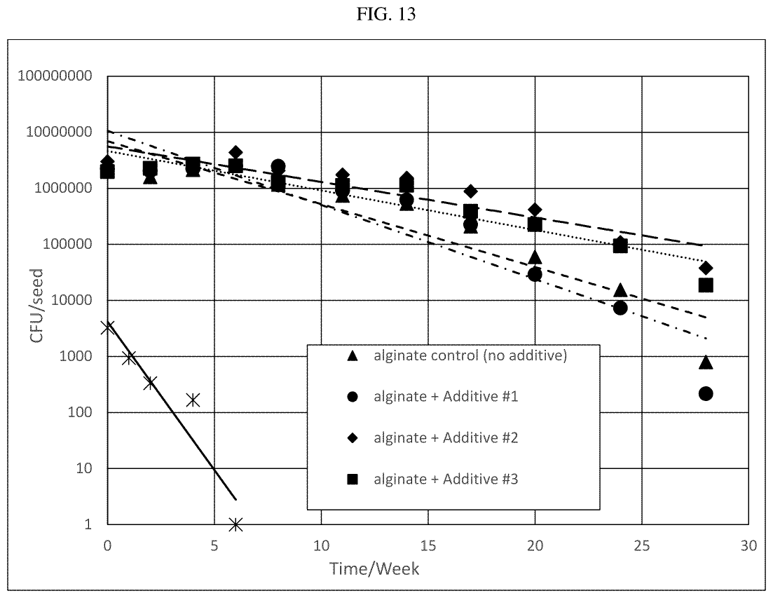

Phytobacter diazotrophicus fermentation was applied directly on-seed to compare the stability of different encapsulated formulations to the on-seed stability of the liquid. The fermentation was applied in a similar manner to the seed treatment described in Example 7, applying 1 mL of fermentation broth directly onto the seeds without any binder. These treated seeds were transferred into poly-lined paper bags (3.375 inches×2.5 inches×10.25 inches; Midco BA TT CW-6L) for long term storage in 25° C./65% RH. As illustrated in FIG. 13, at 25° C./65% RH, the on-seed stability of all the encapsulated formulations is significantly better than the liquid fermentation applied directly on-seed. Formulations made with Additives #2 and #3 had the best on-seed stability. Those formulations had the lowest moisture uptake in the DVS data shown in FIG. 12.

### Example 19. Incorporation of Hydrophobic Additives as an Outer Coating

### Addition of Hydrophobic Coating in Spray Dryer

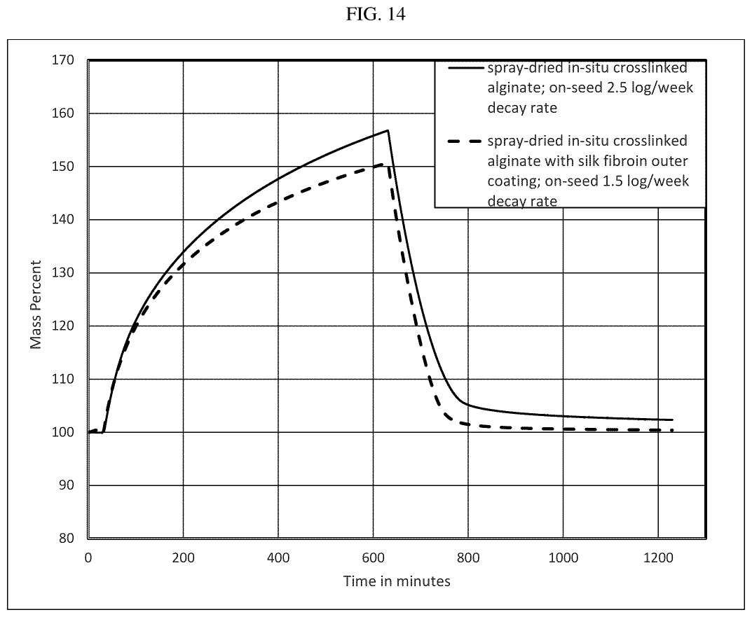

Two types of CAMMs containing Pseudomonas fluorescens were generated using the three fluid nozzle spray drying procedure listed in Example 6. The first formulation used 0.125 wt. % calcium chloride in the outer fluid of the spray dryer to create in-situ crosslinked alginate microparticles. The second formulation used 0.125 wt. % calcium chloride+1 wt. % silk fibroin (supplied as a 5 wt. % from Sigma Aldrich; catalog #5154-20ML). All other spray dryer settings were the same. The moisture absorption of these formulations was compared in the DVS instrument after drying them in a vacuum oven at 40° C. overnight using the following program: 0.5 hours at 0% RH (mass adjusted to 100% afterwards), 10 hours at 90% RH, and 10 hours at 0% RH. The DVS data (FIG. 14) shows that the formulation with the hydrophobic coating absorbs less moisture at the same % RH. These formulations were applied on-seed as described in Example 7. At 25° C./65% RH, the spray-dried in-situ crosslinked alginate formulation demonstrated ˜2.5 log per week decay rate, whereas the formulation that contained silk fibroin in the outer fluid was more stable on-seed with ˜1.5 log per week decay rate.

### Addition of Hydrophobic Coating in Fluid Bed Dryer

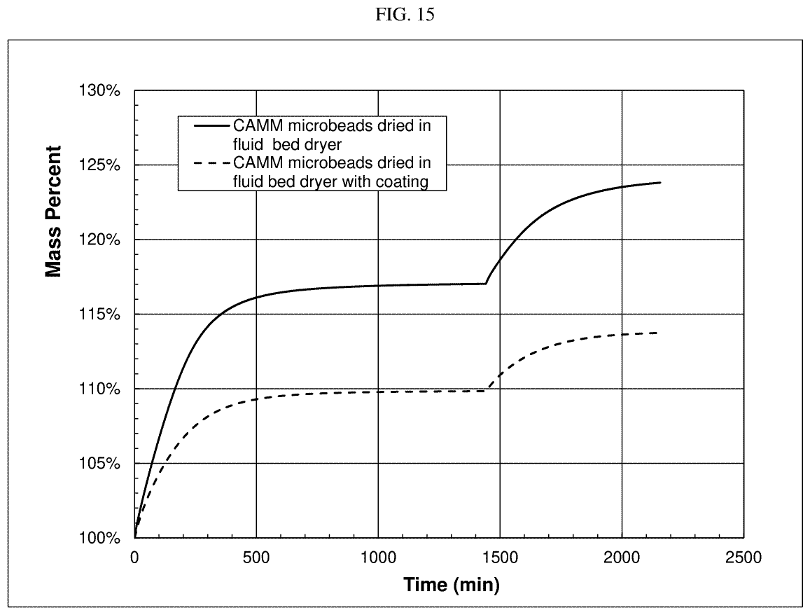

CAMM microbeads containing Bradyrhizobium japonicum were generated using a 200 μm nozzle as described in Example 3. These microbeads were dried in a fluid bed dryer at 40° C. with or without a 10 wt % SURELEASE® (from Colorcon; a 25 wt % aqueous dispersion of ethylcellulose) sprayed onto the wet microbeads while drying. The amount of coating added was ˜5% of the weight of the dried CAMM microbeads without coating. The moisture absorption of these formulations was compared in the DVS instrument after drying them in a vacuum oven at 40° C. overnight using the following program: 24 hours at 65% RH followed by 12 hours at 90% RH. The DVS data (FIG. 15) shows that the formulation with the hydrophobic coating absorbs much less moisture at the same % RH.

Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

The detailed description set-forth above is provided to aid those skilled in the art in practicing the present disclosure. However, the disclosure described and claimed herein is not to be limited in scope by the specific embodiments herein disclosed because these embodiments are intended as illustration of several aspects of the disclosure. Any equivalent embodiments are intended to be within the scope of this disclosure. Various modifications of the disclosure in addition to those shown and described herein will become apparent to those skilled in the art from the foregoing description, which do not depart from the spirit or scope of the present disclosure. Such modifications are also intended to fall within the scope of the appended claims.

What is claimed is:

1. A method for preparing an encapsulated microbial composition, the method comprising:
(a) combining a microbe and at least one hydrogel to form a precursor mixture, wherein the at least one hydrogel comprises an alginate;
(b) solidifying the precursor mixture with a cross-linking agent comprising a divalent cation, a divalent cation salt, or a combination thereof to form an intermediate microbial composition; and
(c) drying the intermediate microbial composition to form the encapsulated microbial composition having a water content less than or equal to about 10%, wherein the drying is performed at a drying temperature of greater than or equal to about 15° C. with an evaporation rate of less than or equal to about 25,000 g/hr/m².

2. (canceled)

3. The method of claim 1, wherein the alginate is selected from the group consisting of sodium alginate, potassium alginate, barium alginate, calcium alginate, magnesium alginate, strontium alginate, and a combination thereof.

4. (canceled)

5. (canceled)

6. The method of claim 1, wherein the precursor mixture comprises a nitrogen-containing stabilizer.

7. (canceled)

8. (canceled)

9. The method of claim 1, wherein the precursor mixture comprises a sugar-containing stabilizer.

10. (canceled)

11. (canceled)

12. (canceled)

13. The method of claim 1, wherein the microbe is a non-spore-forming bacteria.

14. The method of claim 13, wherein the microbe is selected from the group consisting of Pseudomonas, Bradyrhizobium, Herbaspirillum, Phytobacter, Pseudacidovorax, Mitsuaria, Azospirillum, Burkholderia, Chryseomonas, Aeromonas, Acinetobacter, Stenotrophomonas, Chromobacterium, Agrobacterium, Chryseobacterium, Xenorhabdus, Photorhabdus, and a combination thereof.

15. (canceled)

16. (canceled)

17. (canceled)

18. (canceled)

19. (canceled)

20. (canceled)

21. (canceled)

22. The method of claim 1, wherein the solidifying comprises contacting droplets of the precursor mixture with the cross-linking agent, and wherein the intermediate microbial composition is in a form of cross-linked beads.

23. (canceled)

24. The method of claim 1, wherein the solidifying comprises flowing the precursor mixture through an aperture having a diameter of about 100 μm to about 500 μm and contacting the precursor mixture with the cross-linking agent, and wherein the intermediate microbial composition is in a form of cross-linked microbeads.

25. (canceled)

26. (canceled)

27. The method of claim 1, wherein the solidifying comprises high shear mixing of the precursor mixture with the cross-linking agent.

28. (canceled)

29. (canceled)

30. The method of claim 27, wherein the high shear mixing is performed at a temperature of about 4° C. to about 30° C.

31. The method of claim 1, wherein the solidifying comprises combining the precursor mixture with the cross-linking agent to form the intermediate microbial composition, wherein the cross-linking agent comprises the divalent cation salt and the divalent cation salt is a divalent cation carbonate.

32. (canceled)

33. (canceled)

34. The method of claim 31, wherein the solidifying further comprises adding an acidic buffer.

35. The method of claim 34, wherein the acidic buffer is added: (i) to the precursor mixture and/or the cross-linking agent before the cross-linking agent is combined with the precursor mixture; (ii) to the precursor mixture substantially simultaneously along with the cross-linking agent; (iii) to a mixture comprising the precursor mixture and the cross-linking agent; or any combination of (i), (ii), and (iii).

36. (canceled)

37. (canceled)

38. (canceled)

39. (canceled)

40. (canceled)

41. (canceled)

42. (canceled)

43. The method of claim 1, wherein the drying temperature is about 15° C. to about 60° C.

44. (canceled)

45. (canceled)

46. The method of claim 1, wherein the evaporation rate is less than or equal to about 15,000 g/hr/m².

47. (canceled)

48. (canceled)

49. (canceled)

50. The method of claim 1, further comprising processing the encapsulated microbial composition to form encapsulated microbial particles.

51. The method of claim 50, further comprising reducing the size of the encapsulated microbial particles to have an average particle diameter of less than or equal to about 200 μm.

52. The method of claim 51, wherein the reducing the size of the encapsulated microbial particles comprises milling the encapsulated microbial particles.

53. The method of claim 1, wherein the encapsulated microbial composition has a water content of less than or equal to about 5%.

54. (canceled)

55. (canceled)

56. (canceled)

57. (canceled)

58. (canceled)

59. (canceled)

60. The method of claim 1, wherein drying the intermediate microbial composition to form the encapsulated microbial composition includes one or more of air drying the intermediate microbial composition, vacuum drying the intermediate microbial composition, and/or drying the intermediate microbial composition in a fluid bed.

61. (canceled)

62. (canceled)

63. (canceled)

64. (canceled)

65. An encapsulated microbial composition comprising:
a microbe embedded in a polymeric matrix comprising at least one hydrogel bonded together with a divalent cation, wherein the at least one hydrogel comprises an alginate; and wherein the encapsulated microbial composition has a water content of less than or equal to about 10%.

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. A seed composition comprising:
a plant seed; and
the encapsulated microbial composition of claim 65 present on at least a portion of a surface of the plant seed.

91. (canceled)

92. (canceled)

93. (canceled)

94. (canceled)
